(19) United States
(12) Patent Application Publication
(10) Pub. No.: US 2026/0223087 A1
(43) Pub. Date: Jul. 30, 2026

(54) METHOD AND APPARATUS FOR CONFIGURING SENSING RESOURCE, DEVICE, STORAGE MEDIUM

(71) Applicant: Beijing Xiaomi Mobile Software Co., Ltd., Beijing (CN)

(72) Inventor: Mingju LI, Beijing (CN)

(73) Assignee: Beijing Xiaomi Mobile Software Co., Ltd., Beijing (CN)

(21) Appl. No.: 19/147,162

(22) PCT Filed: Jan. 13, 2023
(86) PCT No.: PCT/CN2023/072211

§ 371 Date: Jul. 10, 2025

(51) Int. Cl. H04W 72/0446; H04W 52/52; H04W 72/0453; H04W 72/0457; H04W 72/25

(52) U.S. Cl. CPC H04W 72/0446; H04W 52/52; H04W 72/0453; H04W 72/0457; H04W 72/25

(57) ABSTRACT

A method and a device for configuring a sensing resource are provided. The method includes: receiving resource configuration information sent by a second device, the resource configuration information being used for instructing a resource location wherein a first device transmits a sensing signal, and the resource configuration information including time domain resource configuration information indicating a time domain resource and/or frequency domain resource configuration information indicating a frequency domain resource; and based on the resource location, transmitting the sensing signal, the sensing signal being used for sensing a sensing target.

### CROSS REFERENCE TO RELATED APPLICATIONS

The present disclosure is the U.S. national phase application of International Application No. PCT/CN2023/072211 filed on Jan. 13, 2023, the content of which is incorporated herein by reference in its entirety for all purposes.

### TECHNICAL FIELD

The present disclosure relates to the field of communication technology, in particular, to a method for configuring a sensing resource, an apparatus for configuring a sensing resource, a device and a storage medium.

### BACKGROUND

At present, the research is being conducted on communication sensing technology, which mainly involves scenes where sensing nodes and sensing targets are included. The sensing target can be the object, such as vehicles, buildings, etc., that needs to be sensed. The sensing node can be a node that needs to sense the sensing target by sending and/or receiving sensing signals. For example, the sensing node can be a base station, a mobile phone, an onboarded device, etc. The sensing node wants to sense information such as the distance between the sensing target and itself.

### SUMMARY

According to a first aspect, the present disclosure provides a method for configuring a sensing resource, performed by a first device, the method including: receiving resource configuration information sent by a second device, wherein the resource configuration information is configured to indicate a resource location where the first device transmits a sensing signal, and the resource configuration information includes time-domain resource configuration information indicating a time-domain resource and/or frequency-domain resource configuration information indicating a frequency-domain resource; and transmitting the sensing signal based on the resource location, wherein the sensing signal is used to sense a sensing target.

According to a second aspect, the present disclosure provides a method for configuring a sensing resource, performed by a second device, the method including: sending resource configuration information to a first device, wherein the resource configuration information is configured to indicate a resource location where the first device transmits a sensing signal, the resource configuration information includes time-domain resource configuration information indicating a time-domain resource and/or frequency-domain resource configuration information indicating a frequency-domain resource, the resource configuration information is further configured for the first device to transmit the sensing signal based on the resource location, and the sensing signal is used to sense a sensing target.

According to a third aspect, the present disclosure provides a device for configuring a sensing resource, including: a processor; and a memory used to store executable instructions for the processor; wherein the processor is configured to perform the method as described in the first aspect or any method as described in the first aspect.

According to a fourth aspect, the present disclosure provides a device for configuring a sensing resource, including: a processor; and a memory used to store executable instructions for the processor; wherein the processor is configured to perform the method as described in the second aspect or any method as described in the second aspect.

According to a fifth aspect, the present disclosure provides a non-transitory computer-readable storage medium, when instructions in the storage medium are executed by a processor of a first device, cause the first device to perform the method as described in the first aspect or any method as described in the first aspect.

According to a sixth aspect, the present disclosure provides a non-transitory computer-readable storage medium, when instructions in the storage medium are executed by a processor of a first device, cause the first device to perform the method as described in the second aspect or any method as described in the second aspect.

It should be understood that the general description above and the detailed description in the following are only illustrative and explanatory, and do not limit the present disclosure.

### BRIEF DESCRIPTION OF THE DRAWINGS

The drawings, which are incorporated in and constitute a part of this specification, illustrate embodiments consistent with the present disclosure and serve together with the specification to explain principles of the present disclosure.

FIG. 1 is a schematic diagram of a wireless communication system according to one or more embodiments.

FIG. 2 is a flowchart of a method for configuring a sensing resource according to one or more embodiments.

FIG. 3 is a flowchart of a method for configuring a sensing resource according to one or more embodiments.

FIG. 4 is a schematic diagram of an apparatus for configuring a sensing resource according to one or more embodiments.

FIG. 5 is a schematic diagram of an apparatus for configuring a sensing resource according to one or more embodiments.

FIG. 6 is a schematic diagram of a communication sensing device according to one or more embodiments.

FIG. 7 is a schematic diagram of a communication sensing device according to one or more embodiments.

### DETAILED DESCRIPTION

A detailed explanation of exemplary embodiments, examples of which are illustrated in the drawings, will be provided herein. When the following description involves drawings, unless otherwise indicated, the same numerals in different drawings represent the same or similar elements. The implementation described in the following embodiments do not represent all embodiments consistent with the present disclosure.

The communication method provided in the present disclosure can be applied to a wireless communication system 100 shown in FIG. 1. The network system can include an access network device 110, a terminal 120, and a core network device 130. The core network device can also be referred to as devices in the core network. It can be understood that the wireless communication system shown in FIG. 1 is only for illustrative purposes, and the wireless communication system can also include other network devices, for example, a wireless relay device, a wireless backhaul device, etc., which are not shown in FIG. 1. The number of access network devices, core network devices, and terminals included in the wireless communication system is not limited in embodiments of the present disclosure.

It can be further understood that the wireless communication system disclosed in embodiments of the present disclosure is a network that provides wireless communication functionality. Different communication technologies can be used in the wireless communication systems, such as code division multiple access (CDMA), wideband code division multiple access (WCDMA), time division multiple access (TDMA), frequency division multiple access (FDMA), orthogonal frequency division multiple access (OFDMA), single carrier FDMA (SC-FDMA), and carrier sense multiple access with collision avoidance. Networks can be divided according to factors such as different capacities, rates, and latencies, into 2G (generation) network, 3G network, 4G network, or a future evolved network, such as the 5th generation (5G) wireless communication system network. The 5G network can also be referred to as New Radio (NR). For the convenience of description, the wireless communication network is sometimes referred to as a network in the present disclosure.

Further, the access network device 110 involved in the present disclosure can also include a wireless access network device. The wireless access network device can be a base station, an evolved node B (eNB), a home base station, an access point (AP) in a wireless fidelity (WIFI) system, a wireless relay node, a wireless backhaul node, a transmission point (TP) or a transmission and reception point (TRP), etc. The wireless access network device can also be the gNB in an NR system. Alternatively, the wireless access network device can be a component or a part of devices that constitute the base station. In addition, when in the V2X (Vehicle to Everything) communication system, the access network device can also be an onboard device. It should be understood that specific technologies and forms adopted by the access network device are not limited in embodiments of the present disclosure.

Further, the terminal 120 involved in the present disclosure can also be referred to as a terminal device, user equipment (UE), a mobile station (MS), a mobile terminal (MT), etc., which is a device that provides voice and/or data connection to users. For example, the terminal can be a handheld device, a vehicle mounted device with wireless connection functions, etc. Some examples of terminals include smart mobile phones, pocket personal computers (PPCs), handheld computers, personal digital assistants (PDAs), laptops, tablets, wearable devices, or vehicle onboard devices. In addition, when in the V2X (Vehicle to Everything) communication system, the terminal device can also be an onboard device. It should be understood that specific technologies and forms adopted by the terminal are not limited in embodiments of the present disclosure.

The core network device 130 involved in the present disclosure can include a mobile management entity (MME), a serving gateway (S-GW), etc. in LTE, and correspondingly a service general packet radio service support node (SGSN), a gateway general packet radio service support node (GGSNs, etc. in 3G. In the 5G technology, the core network device is, for example, a next generation-core (NG-Core), a sensing function entity as described in the present disclosure, etc. It should be understood that specific technologies and forms adopted by the core network device are not limited in embodiments of the present disclosure.

In some embodiments of the present disclosure, the access network device 110 and the terminal 120 can use any available wireless communication technology to achieve the data transmission between them. The transmission channel over which the access network device 110 sends data or control information to the terminal 120 is referred to as a downlink (DL), and the transmission channel over which the terminal 120 sends data or control information to the access network device 110 is referred to as an uplink (UL). It can be understood that the access network device involved in some embodiments of the present disclosure can be a base station. The access network device can also be any other possible access network device, and the terminal can be any possible terminal, which is not limited by the present disclosure.

In some embodiments, the data transmission between the access network device 110 and the core network device 130, and the data transmission between the terminal 120 and the core network device 130 can also be achieved using any available wireless communication technology. The core network device can also be any other possible core network device, which is not limited by the present disclosure.

At present, the research is being conducted on communication sensing technology, which mainly involves scenes where sensing nodes and sensing targets are included. The sensing target can be the object, such as vehicles, buildings, etc., that needs to be sensed. The sensing node can be a node that needs to sense the sensing target by sending and/or receiving sensing signals. For example, the sensing node can be an access network device, a mobile phone, an onboarded device, etc. The sensing node wants to sense information such as the distance between the sensing target and itself, for example, including a distance, an angle, a movement speed, etc.

In some embodiments, the sensing modes for sensing the sensing target can include the following six modes. In different modes, the corresponding sensing nodes are also different.

The sensing nodes are between access network devices, including a Sensing Mode 1 and a Sensing Mode 2.

In some embodiments, the Sensing Mode 1 is a mode where an access network device performs both sending and receiving. For example, a gNB sends a sensing signal, which is reflected after reaching the sensing target, and the gNB also receives the reflected sensing signal.

The Sensing Mode 2 involves the sensing signal transmission between different access network devices, where a gNB A sends a sensing signal and a gNB B receives a sensing signal. For example, the gNB A sends a sensing signal, which is reflected after reaching the sensing target, and then the gNB B receives the reflected sensing signal.

The sensing nodes are between terminals, including a Sensing Mode 3 and a Sensing Mode 4.

In some embodiments, the Sensing Mode 3 is a mode where a terminal performs both sending and receiving. For example, a UE sends a sensing signal, which is reflected after reaching the sensing target, and the UE also receives the reflected sensing signal.

The Sensing Mode 4 involves the sensing signal transmission between different terminals, where UE A sends a sensing signal and UE B receives a sensing signal. For example, the UE A sends a sensing signal, which is reflected after reaching the sensing target, and then the UE B receives the reflected sensing signal.

The sensing nodes are between an access network device and a terminal, including a Sensing Mode 5 and a Sensing Mode 6.

In some embodiments, the Sensing Mode 5 is a mode where a UE sends a sensing signal and a gNB receives a sensing signal. For example, the UE sends a sensing signal, which is reflected after reaching the sensing target, and then the gNB receives the reflected sensing signal.

The Sensing Mode 6 a mode where a gNB sends a sensing signal and a UE receives a sensing signal. For example, the gNB sends a sensing signal, which is reflected after reaching the sensing target, and then the UE receives the reflected sensing signal.

However, there is no provision currently on how to configure time-domain and/or frequency-domain resources for each sensing node for different sensing modes.

The present disclosure provides a method, an apparatus, a device, and a storage medium for configuring a sensing resource. The time-frequency domain resources for transmitting sensing signals are configured, so that transmitting sensing signals based on the configured time-frequency domain resources to sense the sensing target can be easily achieved, thereby improving the sensing accuracy.

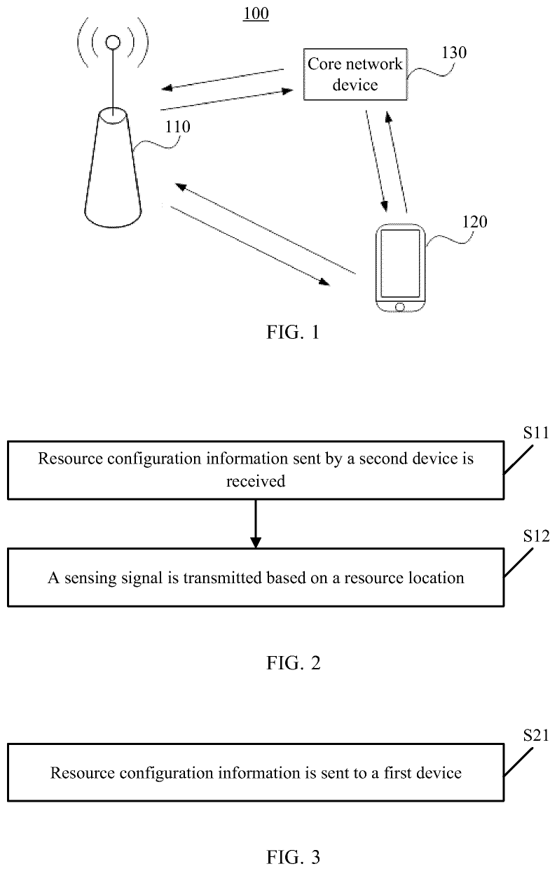

FIG. 2 is a flowchart of a method for configuring a sensing resource according to one or more embodiments. As shown in FIG. 2, the method is performed by a first device and can include the following steps.

In step S11, resource configuration information sent by a second device is received.

In some embodiments, the first device can receive resource configuration information sent by the second device. In some embodiments, the resource configuration information is used to indicate a resource location where the first device transmits a sensing signal. The resource configuration information can include time-domain resource configuration information indicating a time-domain resource, and/or frequency-domain resource configuration information indicating a frequency-domain resource.

In some embodiments, transmitting a sensing signal can include sending a sensing signal and/or receiving a sensing signal.

In step S12, a sensing signal is transmitted based on a resource location.

In some embodiments, the first device can transmit a sensing signal based on the resource location indicated in the resource configuration information received in step S11. In some embodiments, the sensing signal is used to sense the sensing target.

According to the present disclosure, the time-frequency domain resources for transmitting sensing signals are configured, so that transmitting sensing signals based on the configured time-frequency domain resources to sense the sensing target can be easily achieved, thereby improving the sensing accuracy.

In the method for configuring the sensing resource provided in embodiments of the present disclosure, in response that a sensing mode for performing sensing is to use an access network device to transmit a sensing signal, the time-domain resource includes a downlink time slot or a downlink symbol.

In some embodiments, in response to a case where the sensing mode for performing sensing is to use an access network device to transmit a sensing signal, the time-domain resource for transmitting the sensing signal can include the downlink time slot or the downlink symbol.

In some embodiments, the sensing mode can be Sensing Mode 1 or Sensing Mode 2. In these two sensing modes, the access network device which serves as the sensing node can use the time-domain resource occupying the downlink time slot or the downlink symbol when sending and/or receiving sensing signals.

According to the present disclosure, the time-domain resources for transmitting sensing signals in corresponding sensing modes are configured, so that transmitting sensing signals based on the configured time-domain resources to sense the sensing target can be easily achieved, thereby improving the sensing accuracy.

In the method for configuring the sensing resource provided in embodiments of the present disclosure, a last symbol in a time unit where the sensing signal is located is a guard gap symbol, and the guard gap symbol is not used for transmission, or the guard gap symbol is used for repeated transmission between access network devices.

In some embodiments, in the case that the time-domain resource includes the downlink time slot or the downlink symbol, the last symbol in the time unit where the sensing signal is located can be used as a guard gap symbol when transmitting the sensing signal. In some embodiments, the guard gap symbol is not used for transmission, or the guard gap symbol is used for repeated transmission between access network devices.

It can be understood that in the scene of Sensing Mode 2, for example, the gNB A sends a sensing signal, the gNB B receives a sensing signal, and there will be a certain delay when the gNB B receives the sensing signal. It can be understood that if a next symbol after the symbol which the gNB uses to transmit the sensing signal is directly used for new downlink or uplink transmission, the following problem will exist. Due to the delay in the transmission, the symbol used for transmitting the sensing signal and the symbol used for the downlink or uplink transmission will not be aligned. There may be partial overlap between the symbols. Therefore, if the next symbol after the symbol which the gNB uses to transmit the sensing signal is directly used for new downlink or uplink transmission, the gNB will not have enough time to complete the transmission of the sensing signal. Alternatively, if the gNB completes the transmission of the sensing signal, during a short period at the headmost of the next symbol after the symbol which the gNB uses to transmit the sensing signal, the next symbol will overlap with the last symbol which the gNB uses to transmit the sensing signal, and the gNB cannot perform the new downlink or uplink transmission in such a period. The guard gap symbol can compensate for the aforementioned delay.

The guard gap symbol is not used for transmission, indicating that no data is transmitted over the guard gap symbol, that is, the guard gap symbol is Null. Alternatively, the guard gap symbol is not used for transmission, indicating that the guard gap symbol cannot be used for any transmission between access network devices, such as repeated and/or non-repeated transmission.

The guard gap symbol is used for repeated transmission between access network devices, indicating that the guard gap symbol can be used for the repeated transmission of the channel/signal transmitted over the previous symbol(s). Since duplicate data is transmitted on the guard gap symbol, it does not matter whether the device receiving the sensing signal can fully receive the content transmitted over the guard gap symbol.

According to the present disclosure, the configured time-domain resource includes the guard gap symbol, which can compensate for the time delay generated during the transmission of the sensing signal, thereby improving the sensing accuracy when sensing the sensing target.

In the method for configuring the sensing resource provided in embodiments of the present disclosure, in response that a sensing mode for performing sensing is to use an access network device to transmit a sensing signal, the frequency-domain resource includes at least one of the following resources: a sidelink (SL) bandwidth part (BWP), a DL BWP, or a first BWP dedicated to sensing.

In some embodiments, in response to a case where the sensing mode for performing sensing is to use an access network device to transmit a sensing signal, the frequency-domain resource can include the SL BWP.

It can be understood that the frequency-domain resource including the SL BWP means that the SL BWP used for transmission between terminal devices is multiplexed. Because the SL BWP is usually only used over the uplink time slot or the uplink symbol in the system frame structure, but is idle, i.e. not effectively used, over the downlink time slot or the downlink symbol. Therefore, the transmission between access network devices can multiplex the SL BWP over the downlink time slot or the downlink symbol.

In some embodiments, in response to a case where the sensing mode for performing sensing is to use an access network device to transmit a sensing signal, the frequency-domain resource can include the DL BWP.

It can be understood that since the access network device transmits the sensing signal over the downlink time slot or the downlink symbol, the access network device can directly use the DL BWP used for the data transmission between it and the terminal during such a time period. Therefore, the transmission between access network devices can multiplex the DL BWP over the downlink time slot or the downlink symbol.

In some embodiments, in response to a case where the sensing mode for performing sensing is to use an access network device to transmit a sensing signal, the frequency-domain resource can include the first BWP dedicated to sensing.

It can be understood that the first BWP is the BWP used by the access network device to transmit the sensing signal specially. The first BWP is neither a multiplexed SL BWP nor a multiplexed DL BWP.

According to the present disclosure, the frequency-domain resources for transmitting sensing signals in corresponding sensing modes are configured, so that transmitting sensing signals based on the configured frequency-domain resources to sense the sensing target can be easily achieved, thereby improving the sensing accuracy.

In the method for configuring the sensing resource provided in embodiments of the present disclosure, in response that a sensing mode for performing sensing is to use an access network device and a terminal to transmit a sensing signal, the time-domain resource includes at least one of the following: a downlink time slot or a downlink symbol; an uplink time slot or an uplink symbol; or a flexible time slot or symbol.

In some embodiments, in response to a case where the sensing mode for performing sensing is to use an access network device and a terminal to transmit a sensing signal, the time-domain resource can include the downlink time slot or the downlink symbol.

In some embodiments, the sensing mode can be Sensing Mode 5 or Sensing Mode 6. In these two sensing modes, the access network device which serves as the sensing node can use the time-domain resource occupying the downlink time slot or the downlink symbol when sending a downlink sensing signal, and/or, use the time-domain resource occupying the uplink time slot or the uplink symbol when receiving an uplink sensing signal.

In some embodiments, in response to a case where the sensing mode for performing sensing is to use an access network device and a terminal to transmit a sensing signal, the time-domain resource can include the uplink time slot or the uplink symbol.

In some embodiments, the sensing mode can be Sensing Mode 5 or Sensing Mode 6. In these two sensing modes, the terminal which serves as the sensing node can use the time-domain resource occupying the uplink time slot or the uplink symbol when sending an uplink sensing signal, and/or, use the time-domain resource occupying the downlink time slot or the downlink symbol when receiving a downlink sensing signal.

In some embodiments, in response to a case where the sensing mode for performing sensing is to use an access network device and a terminal to transmit a sensing signal, the time-domain resource can include the flexible time slot or symbol.

In some embodiments, when configuring a time slot format using the Radio Resource Control (RRC) signaling, the flexible time slot or the flexible symbol can be configured. Such flexible time-domain resources can be further configured, through the Downlink Control Information (DCI) or other configuration information of the access network device, as the uplink time slot or the uplink symbol, or further as the downlink time slot or the downlink symbol. In some embodiments, the other configuration information can be random access resource configuration information or reference signal resource configuration information, etc., which is not limited in the present disclosure.

In some embodiments, in response to a case where the sensing mode for performing sensing is to use an access network device and a terminal to transmit a sensing signal, the time-domain resource can include following combinations: a downlink time slot or a downlink symbol, and an uplink time slot or an uplink symbol; a downlink time slot or a downlink symbol, and a flexible time slot or symbol; an uplink time slot or an uplink symbol, and a flexible time slot or symbol; a downlink time slot or a downlink symbol, an uplink time slot or an uplink symbol, and a flexible time slot or symbol.

According to the present disclosure, the time-domain resources for transmitting sensing signals in corresponding sensing modes are configured, so that transmitting sensing signals based on the configured time-domain resources to sense the sensing target can be easily achieved, thereby improving the sensing accuracy.

In the method for configuring the sensing resource provided in embodiments of the present disclosure, in response that a sensing mode for performing sensing is to use an access network device and a terminal to transmit a sensing signal, the frequency-domain resource includes at least one of the following resources: a DL BWP; an UL BWP; or a second BWP dedicated to sensing.

In some embodiments, in response to a case where the sensing mode for performing sensing is to use an access network device and a terminal to transmit a sensing signal, the frequency-domain resource can include the DL BWP.

In some embodiments, the access network device which serves as the sensing node can directly use the DL BWP used for the data transmission between it and the terminal when sending a downlink sensing signal. Additionally and alternatively, the terminal which serves as the sensing node can directly use the DL BWP used for the data transmission between it and the access network device when receiving a downlink sensing signal.

In some embodiments, in response to a case where the sensing mode for performing sensing is to use an access network device and a terminal to transmit a sensing signal, the frequency-domain resource can include the UL BWP.

In some embodiments, the terminal which serves as the sensing node can directly use the UL BWP used for the data transmission between it and the access network device when sending an uplink sensing signal. Additionally and alternatively, the access network device which serves as the sensing node can directly use the UL BWP used for the data transmission between it and the terminal when receiving an uplink sensing signal.

In some embodiments, in response to a case where the sensing mode for performing sensing is to use an access network device and a terminal to transmit a sensing signal, the frequency-domain resource can include the second BWP dedicated to sensing.

It can be understood that the second BWP is the BWP used by the access network device and/or the terminal to transmit the sensing signal specially. The second BWP is neither a multiplexed DL BWP nor a multiplexed UL BWP.

In some embodiments, in response to a case where the sensing mode for performing sensing is to use an access network device and a terminal to transmit a sensing signal, the frequency-domain resource can include following combinations: a DL BWP, and an UL BWP; a DL BWP, and a second BWP dedicated to sensing; an UL BWP, and a second BWP dedicated to sensing; a DL BWP, an UL BWP, and a second BWP dedicated to sensing.

According to the present disclosure, the frequency-domain resources for transmitting sensing signals in corresponding sensing modes are configured, so that transmitting sensing signals based on the configured frequency-domain resources to sense the sensing target can be easily achieved, thereby improving the sensing accuracy.

In the method for configuring the sensing resource provided in embodiments of the present disclosure, the resource configuration information is determined by at least one of the following ways: the resource configuration information is determined by an access network device, or the resource configuration information is determined by a sensing function entity.

In some embodiments, the resource configuration information can be determined by the access network device.

In some embodiments, in response to a case where the sensing mode for performing sensing is to use an access network device to transmit a sensing signal, for example, the Sensing Mode 1. If the sending and receiving of sensing signals are performed by the same access network device, the resource configuration information can be determined by the access network device itself.

In some embodiments, in response to a case where the sensing mode for performing sensing is to use an access network device to transmit a sensing signal, for example, the Sensing Mode 2, where the GNB A sends the sensing signal and the gNB B receives the sensing signal. The resource configuration information can be determined by the gNB A and/or the gNB B through the Xn interface between the gNB A and the gNB B. The resource configuration information can also be determined by the gNB A and informed to the gNB B, or the resource configuration information is determined by the gNB B and informed to the gNB A.

In some embodiments, after determining the resource configuration information, the access network device can send the determined resource configuration information to the sensing function entity. That is, the access network device informs the sensing function entity of the resource configuration information. In some embodiments, the access network device can also not inform the sensing function entity of the determined resource configuration information.

In some embodiments, in response to a case where the sensing mode for performing sensing is to use an access network device and a terminal to transmit a sensing signal, for example, the Sensing Mode 5 and/or the Sensing Mode 6. After determining the resource configuration information, the access network device can directly inform the terminal. Alternatively, the access network device can inform the sensing function entity of the resource configuration information, and then the sensing function entity can inform the terminal.

In some embodiments, the resource configuration information can be determined by the sensing function entity.

In some embodiments, in scenes of Sensing Mode 1, Sensing Mode 2, Sensing Mode 5, and/or Sensing Mode 6, the access network device can inform the sensing function entity of its available resources. Afterwards, the sensing function entity determines one or more available resources based on available resources of one or more access network devices, and obtains the resource configuration information. Then, the sensing function entity informs the one or more access network devices or the terminal(s) of the determined resource configuration information.

In some embodiments, the resource configuration information can be determined by the access network device and the sensing function entity.

The present disclosure provides multiple ways to determine the resource configuration information, based on which, the time-frequency domain resources for transmitting sensing signals in corresponding sensing modes can be configured, so that transmitting sensing signals based on the configured time-frequency domain resources to sense the sensing target can be easily achieved, thereby improving the sensing accuracy.

In the method for configuring the sensing resource provided in embodiments of the present disclosure, in response that a sensing mode for performing sensing is to use a terminal to transmit a sensing signal, the time-domain resource includes an uplink time slot or an uplink symbol.

In some embodiments, in response to a case where the sensing mode for performing sensing is to use a terminal to transmit a sensing signal, the time-domain resource for transmitting the sensing signal can include the uplink time slot or the uplink symbol.

In some embodiments, the sensing mode can be Sensing Mode 3 or Sensing Mode 4. In these two sensing modes, the terminal which serves as the sensing node can use the time-domain resource occupying the uplink time slot or the uplink symbol when sending and/or receiving sensing signals.

According to the present disclosure, the time-domain resources for transmitting sensing signals in corresponding sensing modes are configured, so that transmitting sensing signals based on the configured time-domain resources to sense the sensing target can be easily achieved, thereby improving the sensing accuracy.

In the method for configuring the sensing resource provided in embodiments of the present disclosure, a last symbol in a time unit where the sensing signal is located is a guard gap symbol, and a first symbol in the time unit where the sensing signal is located is an automatic gain control (AGC) symbol. The guard gap symbol is not used for transmission, or the guard gap symbol is used for repeated transmission between terminals.

In some embodiments, in the case that the time-domain resource includes the uplink time slot or the uplink symbol, the last symbol in the time unit where the sensing signal is located can be used as a guard gap symbol during transmission. In some embodiments, the guard gap symbol is not used for transmission, or the guard gap symbol is used for repeated transmission between terminals. In some embodiments, the first symbol in the time unit where the sensing signal is located is the AGC symbol. The AGC symbol is mainly used for power adjustment.

It can be understood that, similar to the signal transmission in the sidelink, there is also a delay in transmitting sensing signals between different terminals. Therefore, when transmitting sensing signals, the last symbol in the time unit where the sensing signal is located needs to compensate for such delay. That is, when transmitting sensing signals, the last symbol in the time unit where the sensing signal is located is used as the guard gap symbol. Moreover, in consideration that the location of the terminal usually changes flexibly, and thus the distance between different terminals usually changes quickly. Therefore, when transmitting sensing signals, it is necessary to use the first symbol in the time unit where the sensing signal is located for power adjustment, that is, the first symbol in the time unit where the sensing signal is located is used as the AGC symbol.

According to the present disclosure, the configured time-domain resource includes the guard gap symbol, which can compensate for the time delay generated during the transmission of the sensing signal, thereby improving the sensing accuracy when sensing the sensing target.

In the method for configuring the sensing resource provided in embodiments of the present disclosure, in response that a sensing mode for performing sensing is to use a terminal to transmit a sensing signal, the frequency-domain resource includes at least one of the following resources: a SL BWP; an UL BWP; or a third BWP dedicated to sensing.

In some embodiments, in response to a case where the sensing mode for performing sensing is to use a terminal to transmit a sensing signal, the frequency-domain resource can include the SL BWP.

It can be understood that the frequency-domain resource including the SL BWP means that the SL BWP used for transmission between terminal devices is multiplexed. When the terminal uses the SL BWP to transmit the sensing signal, the sensing signal can be multiplexed with other SL signals or channels. In some embodiments, the transmission can be performed using time division multiplexing (TDM), frequency division multiplexing (FDM), space division multiplexing (SDM), or groups of different demodulation reference signal (DMRS) ports.

In some embodiments, in response to a case where the sensing mode for performing sensing is to use a terminal to transmit a sensing signal, the frequency-domain resource can include the UL BWP.

It can be understood that since the terminal transmits the sensing signal over the uplink time slot or the uplink symbol, the terminal can directly use the UL BWP used for the data transmission between it and the access network device during such a time period. Therefore, the transmission between terminals can multiplex the UL BWP over the uplink time slot or the uplink symbol.

In some embodiments, in response to a case where the sensing mode for performing sensing is to use a terminal to transmit a sensing signal, the frequency-domain resource can include the third BWP dedicated to sensing.

It can be understood that the third BWP is the BWP used by the terminal to transmit the sensing signal specially. The third BWP is neither a multiplexed SL BWP nor a multiplexed DL BWP.

It should be noted that the first BWP, the second BWP, and the third BWP involved in the present disclosure can be the same or different, which is not limited in the present disclosure.

According to the present disclosure, the frequency-domain resources for transmitting sensing signals in corresponding sensing modes are configured, so that transmitting sensing signals based on the configured frequency-domain resources to sense the sensing target can be easily achieved, thereby improving the sensing accuracy.

In the method for configuring the sensing resource provided in embodiments of the present disclosure, the resource configuration information is determined by at least one of the following ways: the resource configuration information is determined by an access network device, the resource configuration information is determined by a sensing function entity, or the resource configuration information is determined by a terminal based on resources in a resource pool.

In some embodiments, the resource configuration information can be determined by the access network device.

In some embodiments, in response to a case where the sensing mode for performing sensing is to use a terminal to transmit a sensing signal, for example, the Sensing Mode 3 and/or the Sensing Mode 4. The resource configuration information can be determined by the access network device and then informed to the terminal.

In some embodiments, after determining the resource configuration information, the access network device can send the determined resource configuration information to the sensing function entity. That is, the access network device informs the sensing function entity of the resource configuration information. In some embodiments, the access network device can also not inform the sensing function entity of the determined resource configuration information.

In some embodiments, the resource configuration information can be determined by the sensing function entity.

In some embodiments, in scenes of Sensing Mode 3 and/or Sensing Mode 4, the access network device can inform the sensing function entity of its available resources. Afterwards, based on one or more available resources, the sensing function entity determines one or more available resources for both the terminal and/or the access network device, and obtains the resource configuration information. Then, the sensing function entity informs one or more terminals of the determined resource configuration information.

In some embodiments, the sensing function entity can also inform the access network device of the determined resource configuration information.

In some embodiments, the resource configuration information can be determined by the terminal based on the resources in the resource pool.

In some embodiments, similar to the SL resource allocation, the access network device can allocate or indicate a resource pool. The terminal selects and reserves corresponding resources based on the resource pool by itself, and determines the resource configuration information for transmitting sensing signals.

In some embodiments, the resource configuration information can also be determined by the access network device and the sensing function entity, or determined by the access network device and the terminal based on the resources in the resource pool, or determined by the sensing function entity and the terminal based on the resources in the resource pool, or determined by the access network device, the sensing function entity, and the terminal based on the resources in the resource pool.

The present disclosure provides multiple ways to determine the resource configuration information, based on which, the time-frequency domain resources for transmitting sensing signals in corresponding sensing modes can be configured, so that transmitting sensing signals based on the configured time-frequency domain resources to sense the sensing target can be easily achieved, thereby improving the sensing accuracy.

In the method for configuring the sensing resource provided in embodiments of the present disclosure, the time unit is either a slot or a mini-slot.

In some embodiments, the time unit where the sensing signal is located can be a slot.

In some embodiments, the time unit where the sensing signal is located can be a mini-slot.

It can be understood that the mini-slot is a sub slot architecture. The mini-slot transforms the smallest scheduling unit from a time slot to a symbol, so as to achieve symbol-level scheduling, which can reduce the waiting time for data transmission and is suitable for a scene of low latency and small data volume.

In some embodiments, the features of the mini-slot can include at least one of the following: a slot can contain multiple mini-slot time units, a mini-slot can occupy symbols over multiple slots, or a mini-slot contains a minimum of 1 or 2 symbols.

The present disclosure is adapted to scenes in which multiple time units are supported. According to the present disclosure, the time-domain resources for transmitting sensing signals in corresponding sensing modes are configured, so that transmitting sensing signals based on the configured time-domain resources to sense the sensing target can be easily achieved, thereby improving the sensing accuracy.

In the method for configuring the sensing resource provided in embodiments of the present disclosure, the time-domain resource configuration information includes at least one of following parameters: a period, a starting time slot location, a starting symbol location, a number of occupied symbols, a number of sensing signal resources within a resource window for sending a sensing signal, or a number of time slots or symbols spaced between adjacent sensing signal resources within a resource window for sending a sensing signal.

In some embodiments, the time-domain resource configuration information can include a period.

For example, the time-domain resource configuration information includes a period of a sensing signal resource, a period of a resource window for sending a sensing signal, etc.

In some embodiments, the time-domain resource configuration information can include a starting time slot location.

For example, the time-domain resource configuration information includes a starting time slot location of the sensing signal resource or a starting time slot location of the resource window for sending a sensing signal.

In some embodiments, the time-domain resource configuration information can include a starting symbol location.

For example, the time-domain resource configuration information includes a starting symbol location of the sensing signal resource or a starting symbol location of the resource window for sending a sensing signal.

In some embodiments, the time-domain resource configuration information can include a number of occupied symbols.

For example, the time-domain resource configuration information includes a number of symbols occupied by the sensing signal resource.

In some embodiments, the time-domain resource configuration information can include a number of sensing signal resources within a resource window for sending a sensing signal.

For example, the time-domain resource configuration information includes a number of sensing signal resources within a window for sending a sensing signal. It can be understood that the sensing signal can be sent for multiple times within a window for sending a sensing signal. However, if some sensing signal resource is occupied by other channels/signals, the sensing signal will not be able to be sent on the corresponding sensing signal resource. Also, for different devices, there may be some resource locations that cannot be used for transmitting the data. That is, the number of sensing signal resources within the window for sending a sensing signal represents the number of sensing signal resources that can be used for transmitting sensing signals within a sensing signal window.

In some embodiments, the time-domain resource configuration information can include a number of time slots or symbols spaced between adjacent sensing signal resources within a resource window for sending a sensing signal.

For example, the time-domain resource configuration information includes a number of time slots spaced between adjacent two sensing signal resources within the resource window for sending a sensing signal, or a number of symbols spaced between adjacent two sensing signal resources within the resource window for sending a sensing signal.

In some embodiments, the time-domain resource configuration information can also include following combinations: a period, and a starting time slot location; a starting symbol location, a number of occupied symbols, and a number of sensing signal resources within a resource window for sending a sensing signal; a period, a starting time slot location, a starting symbol location, and a number of occupied symbols; a period, a starting time slot location, a starting symbol location, a number of occupied symbols, and a number of sensing signal resources within a resource window for sending a sensing signal; a period, a starting time slot location, a starting symbol location, a number of occupied symbols, a number of sensing signal resources within a resource window for sending a sensing signal, and a number of time slots or symbols spaced between adjacent sensing signal resources within a resource window for sending a sensing signal.

It can be understood that the time-domain resource configuration information provided in the present disclosure can also include any two, three, four, five, or six items mentioned above, which will not be listed one by one here.

The present disclosure provides multiple parameter configurations for the time-domain resources, based on which, the time-domain resources for transmitting sensing signals in corresponding sensing modes can be configured, so that transmitting sensing signals based on the configured time-domain resources to sense the sensing target can be easily achieved, thereby improving the sensing accuracy.

In the method for configuring the sensing resource provided in embodiments of the present disclosure, the frequency-domain resource configuration information includes at least one of following parameters: a bandwidth, a starting physical resource block (PRB) location, a comb value, or a starting resource element (RE) location.

In some embodiments, the frequency-domain resource configuration information can include a bandwidth.

In some embodiments, the frequency-domain resource configuration information can include a starting PRB location.

In some embodiments, the frequency-domain resource configuration information can include a comb value.

For example, a PRB contains 12 REs, and a sensing signal only occupies a portion of REs. For example, if two sensing signals occupy all 12 REs, then the comb value is 2. One of the two sensing signals occupies the 1^{st}, 3^{rd}, 5^{th}, . . . , 11^{th} RE, and the other sensing signal occupies the 2^{nd}, 4^{th}, 6^{th}, . . . , 12^{th} RE. It can be understood that the comb value represents a spaced value of the sensing signal occupying the RE, that is, a number of REs spaced between adjacent REs among REs respectively occupied by the sensing signals.

In some embodiments, the frequency-domain resource configuration information can include a starting RE location.

For example, assuming that the comb value is 2, the starting RE location can be the first RE, i.e. RE #0, or the second RE, i.e. RE #1. For example, if the comb value is 3, the starting RE location can be the first RE, i.e. RE #0, the second RE, i.e. RE #1, or the third RE, i.e. RE #2.

In some embodiments, the frequency-domain resource configuration information can also include following combinations: a bandwidth, and a starting PRB location; a bandwidth, and a comb value; a bandwidth, and a starting RE location; a starting PRB location, and a comb value; a starting PRB location, and a starting RE location; a comb value, and a starting RE location; a bandwidth, a starting PRB location, and a comb value; a bandwidth, a starting PRB location, and a starting RE location; a bandwidth, a comb value, and a starting RE location; a starting PRB location, a comb value, and a starting RE location; a bandwidth, a starting PRB location, a comb value, and a starting RE location.

The present disclosure provides multiple parameter configurations for the frequency-domain resources, based on which, the frequency-domain resources for transmitting sensing signals in corresponding sensing modes can be configured, so that transmitting sensing signals based on the configured frequency-domain resources to sense the sensing target can be easily achieved, thereby improving the sensing accuracy.

In the method for configuring the sensing resource provided in embodiments of the present disclosure, the resource configuration information also includes at least one of following parameters: subcarrier spacing, a cyclic prefix (CP), quasi co-location (QCL) information, a sensing signal resource identifier, a sensing signal sequence identifier, power information, or a path loss reference signal.

In some embodiments, the resource configuration information also includes the subcarrier spacing.

In some embodiments, the resource configuration information also includes the CP.

In some embodiments, the resource configuration information also includes the QCL information.

In some embodiments, the QCL information can include a transmission configuration indication (TCI) state or spatial relationship information. It can be understood that the QCL information can include downlink receiving beam information, uplink transmitting beam information, and beam information for SL. The beam information for SL can also indicate the reference signal identifier of the SL reference signal, for example, the sidelink synchronization signal/physical sidelink broadcast channel block (S-SSB) and/or the SL channel state information reference signal (CSI-RS).

It can be understood that the identifier in the present disclosure can be an identity (ID) or an index.

In some embodiments, the resource configuration information also includes the sensing signal resource identifier.

For example, the resource configuration information also includes the sensing signal resource ID.

In some embodiments, the resource configuration information also includes the sensing signal sequence identifier.

For example, the resource configuration information also includes the sensing signal sequence ID. It can be understood that the sensing signal sequence represents various different sensing signals.

In some embodiments, the resource configuration information also includes the power information.

In some embodiments, the resource configuration information also includes the path loss reference signal.

In some embodiments, the resource configuration information also includes following combinations: subcarrier spacing, and a CP; QCL information, a sensing signal resource identifier, and a sensing signal sequence identifier; subcarrier spacing, a CP, QCL information, and a sensing signal resource identifier; subcarrier spacing, a CP, QCL information, a sensing signal resource identifier, and a sensing signal sequence identifier; subcarrier spacing, a CP, QCL information, a sensing signal resource identifier, a sensing signal sequence identifier, and power information; subcarrier spacing, a CP, QCL information, a sensing signal resource identifier, a sensing signal sequence identifier, power information, and a path loss reference signal.

It can be understood that the resource configuration information includes the time-domain resource and/or the frequency-domain resource, and can also include any two, three, four, five, six, or seven parameters mentioned above, which will not be listed one by one in the present disclosure.

The present disclosure provides multiple parameter configurations for the resource configuration information, based on which, the time-frequency domain resources for transmitting sensing signals in corresponding sensing modes can be configured, so that transmitting sensing signals based on the configured time-frequency domain resources to sense the sensing target can be easily achieved, thereby improving the sensing accuracy.

In the method for configuring the sensing resource provided in embodiments of the present disclosure, the first device is an access network device or a terminal, and the second device is an access network device or a terminal different from the first device, or a sensing function entity. In some embodiments, the first device can be an access network device.

In some embodiments, the first device can be a terminal.

In some embodiments, the second device can be an access network device. It can be understood that the second device is an access network device different from the first device.

In some embodiments, the second device can be a terminal. It can be understood that the second device is a terminal different from the first device.

In some embodiments, the second device can be a sensing function entity.

The present disclosure is applicable to various device scenes. According to the present disclosure, the time-frequency domain resources for transmitting sensing signals in corresponding sensing modes are configured, so that transmitting sensing signals based on the configured time-frequency domain resources to sense the sensing target can be easily achieved, thereby improving the sensing accuracy.

Based on the same concept, the present disclosure also provides a method for configuring a sensing resource, which is performed by a second device.

FIG. 3 is a flowchart of a method for configuring a sensing resource according to one or more embodiments. As shown in FIG. 3, the method is performed by a second device and can include the following step.

In step S21, resource configuration information is sent to a first device.

In some embodiments, the second device can send resource configuration information to the first device. In some embodiments, the resource configuration information is used to indicate a resource location where the first device transmits a sensing signal. The resource configuration information can include time-domain resource configuration information indicating a time-domain resource, and/or frequency-domain resource configuration information indicating a frequency-domain resource.

In some embodiments, the resource configuration information is also used for the first device to transmit a sensing signal based on the resource location. In some embodiments, the sensing signal is used to sense the sensing target.

In some embodiments, transmitting a sensing signal can include sending a sensing signal and/or receiving a sensing signal.

According to the present disclosure, the time-frequency domain resources for transmitting sensing signals are configured, so that transmitting sensing signals based on the configured time-frequency domain resources to sense the sensing target can be easily achieved, thereby improving the sensing accuracy.

In the method for configuring the sensing resource provided in embodiments of the present disclosure, in response that a sensing mode for performing sensing is to use an access network device to transmit a sensing signal, the time-domain resource includes a downlink time slot or a downlink symbol.

In some embodiments, in response to a case where the sensing mode for performing sensing is to use an access network device to transmit a sensing signal, the time-domain resource for transmitting the sensing signal can include the downlink time slot or the downlink symbol.

In some embodiments, the sensing mode can be Sensing Mode 1 or Sensing Mode 2. In these two sensing modes, the access network device which serves as the sensing node can use the time-domain resource occupying the downlink time slot or the downlink symbol when sending and/or receiving sensing signals.

According to the present disclosure, the time-domain resources for transmitting sensing signals in corresponding sensing modes are configured, so that transmitting sensing signals based on the configured time-domain resources to sense the sensing target can be easily achieved, thereby improving the sensing accuracy.

In the method for configuring the sensing resource provided in embodiments of the present disclosure, a last symbol in a time unit where the sensing signal is located is a guard gap symbol, and the guard gap symbol is not used for transmission, or the guard gap symbol is used for repeated transmission between access network devices.

In some embodiments, in the case that the time-domain resource includes the downlink time slot or the downlink symbol, the last symbol in the time unit where the sensing signal is located can be used as a guard gap symbol when transmitting the sensing signal. In some embodiments, the guard gap symbol is not used for transmission, or the guard gap symbol is used for repeated transmission between access network devices.

It can be understood that in the scene of Sensing Mode 2, for example, the gNB A sends a sensing signal, the gNB B receives a sensing signal, and there will be a certain delay when the gNB B receives the sensing signal. It can be understood that if a next symbol after the symbol which the gNB uses to transmit the sensing signal is directly used for new downlink or uplink transmission, the following problem will exist. Due to the delay in the transmission, the symbol used for transmitting the sensing signal and the symbol used for the downlink or uplink transmission will not be aligned. There may be partial overlap between the symbols. Therefore, if the next symbol after the symbol which the gNB uses to transmit the sensing signal is directly used for new downlink or uplink transmission, the gNB will not have enough time to complete the transmission of the sensing signal. Alternatively, if the gNB completes the transmission of the sensing signal, during a short period at the headmost of the next symbol after the symbol which the gNB uses to transmit the sensing signal, the next symbol will overlap with the last symbol which the gNB uses to transmit the sensing signal, and the gNB cannot perform the new downlink or uplink transmission in such a period. The guard gap symbol can compensate for the aforementioned delay.

The guard gap symbol is not used for transmission, indicating that no data is transmitted over the guard gap symbol, that is, the guard gap symbol is Null. Alternatively, the guard gap symbol is not used for transmission, indicating that the guard gap symbol cannot be used for any transmission between access network devices, such as repeated and/or non-repeated transmission.

The guard gap symbol is used for repeated transmission between access network devices, indicating that the guard gap symbol can be used for the repeated transmission of the channel/signal transmitted over the previous symbol(s). Since duplicate data is transmitted on the guard gap symbol, it does not matter whether the device receiving the sensing signal can fully receive the content transmitted over the guard gap symbol.

In the method for configuring the sensing resource provided in embodiments of the present disclosure, in response that a sensing mode for performing sensing is to use an access network device to transmit a sensing signal, the frequency-domain resource includes at least one of the following resources: a SL BWP, a DL BWP, or a first BWP dedicated to sensing.

In some embodiments, in response to a case where the sensing mode for performing sensing is to use an access network device to transmit a sensing signal, the frequency-domain resource can include the SL BWP.

It can be understood that the frequency-domain resource including the SL BWP means that the SL BWP used for transmission between terminal devices is multiplexed. Because the SL BWP is usually only used over the uplink time slot or the uplink symbol in the system frame structure, but is idle, i.e. not effectively used, over the downlink time slot or the downlink symbol. Therefore, the transmission between access network devices can multiplex the SL BWP over the downlink time slot or the downlink symbol.

In some embodiments, in response to a case where the sensing mode for performing sensing is to use an access network device to transmit a sensing signal, the frequency-domain resource can include the DL BWP.

It can be understood that since the access network device transmits the sensing signal over the downlink time slot or the downlink symbol, the access network device can directly use the DL BWP used for the data transmission between it and the terminal during such a time period. Therefore, the transmission between access network devices can multiplex the DL BWP over the downlink time slot or the downlink symbol.

In some embodiments, in response to a case where the sensing mode for performing sensing is to use an access network device to transmit a sensing signal, the frequency-domain resource can include the first BWP dedicated to sensing.

It can be understood that the first BWP is the BWP used by the access network device to transmit the sensing signal specially. The first BWP is neither a multiplexed SL BWP nor a multiplexed DL BWP.

According to the present disclosure, the frequency-domain resources for transmitting sensing signals in corresponding sensing modes are configured, so that transmitting sensing signals based on the configured frequency-domain resources to sense the sensing target can be easily achieved, thereby improving the sensing accuracy.

In the method for configuring the sensing resource provided in embodiments of the present disclosure, in response that a sensing mode for performing sensing is to use an access network device and a terminal to transmit a sensing signal, the time-domain resource includes at least one of the following: a downlink time slot or a downlink symbol; an uplink time slot or an uplink symbol; or a flexible time slot or symbol.

In some embodiments, in response to a case where the sensing mode for performing sensing is to use an access network device and a terminal to transmit a sensing signal, the time-domain resource can include the downlink time slot or the downlink symbol.

In some embodiments, the sensing mode can be Sensing Mode 5 or Sensing Mode 6. In these two sensing modes, the access network device which serves as the sensing node can use the time-domain resource occupying the downlink time slot or the downlink symbol when sending a downlink sensing signal, and/or, use the time-domain resource occupying the uplink time slot or the uplink symbol when receiving an uplink sensing signal.

In some embodiments, in response to a case where the sensing mode for performing sensing is to use an access network device and a terminal to transmit a sensing signal, the time-domain resource can include the uplink time slot or the uplink symbol.

In some embodiments, the sensing mode can be Sensing Mode 5 or Sensing Mode 6. In these two sensing modes, the terminal which serves as the sensing node can use the time-domain resource occupying the uplink time slot or the uplink symbol when sending an uplink sensing signal, and/or, use the time-domain resource occupying the downlink time slot or the downlink symbol when receiving a downlink sensing signal.

In some embodiments, in response to a case where the sensing mode for performing sensing is to use an access network device and a terminal to transmit a sensing signal, the time-domain resource can include the flexible time slot or symbol.

In some embodiments, when configuring a time slot format using RRC signaling, the flexible time slot or the flexible symbol can be configured. Such flexible time-domain resources can be further configured, through the DCI or other configuration information of the access network device, as the uplink time slot or the uplink symbol, or further as the downlink time slot or the downlink symbol. In some embodiments, the other configuration information can be random access resource configuration information or reference signal resource configuration information, etc., which is not limited in the present disclosure.

In some embodiments, in response to a case where the sensing mode for performing sensing is to use an access network device and a terminal to transmit a sensing signal, the time-domain resource can include following combinations: a downlink time slot or a downlink symbol, and an uplink time slot or an uplink symbol; a downlink time slot or a downlink symbol, and a flexible time slot or symbol; an uplink time slot or an uplink symbol, and a flexible time slot or symbol; a downlink time slot or a downlink symbol, an uplink time slot or an uplink symbol, and a flexible time slot or symbol.

According to the present disclosure, the time-domain resources for transmitting sensing signals in corresponding sensing modes are configured, so that transmitting sensing signals based on the configured time-domain resources to sense the sensing target can be easily achieved, thereby improving the sensing accuracy.

In the method for configuring the sensing resource provided in embodiments of the present disclosure, in response that a sensing mode for performing sensing is to use an access network device and a terminal to transmit a sensing signal, the frequency-domain resource includes at least one of the following resources: a DL BWP; an UL BWP; or a second BWP dedicated to sensing.

In some embodiments, in response to a case where the sensing mode for performing sensing is to use an access network device and a terminal to transmit a sensing signal, the frequency-domain resource can include the DL BWP.

In some embodiments, the access network device which serves as the sensing node can directly use the DL BWP used for the data transmission between it and the terminal when sending a downlink sensing signal. Additionally and alternatively, the terminal which serves as the sensing node can directly use the DL BWP used for the data transmission between it and the access network device when receiving a downlink sensing signal.

In some embodiments, in response to a case where the sensing mode for performing sensing is to use an access network device and a terminal to transmit a sensing signal, the frequency-domain resource can include the UL BWP.

In some embodiments, the terminal which serves as the sensing node can directly use the UL BWP used for the data transmission between it and the access network device when sending an uplink sensing signal. Additionally and alternatively, the access network device which serves as the sensing node can directly use the UL BWP used for the data transmission between it and the terminal when receiving an uplink sensing signal.

In some embodiments, in response to a case where the sensing mode for performing sensing is to use an access network device and a terminal to transmit a sensing signal, the frequency-domain resource can include the second BWP dedicated to sensing.

It can be understood that the second BWP is the BWP used by the access network device and/or the terminal to transmit the sensing signal specially. The second BWP is neither a multiplexed DL BWP nor a multiplexed UL BWP.

In some embodiments, in response to a case where the sensing mode for performing sensing is to use an access network device and a terminal to transmit a sensing signal, the frequency-domain resource can include following combinations: a DL BWP, and an UL BWP; a DL BWP, and a second BWP dedicated to sensing; an UL BWP, and a second BWP dedicated to sensing; a DL BWP, an UL BWP, and a second BWP dedicated to sensing.

According to the present disclosure, the frequency-domain resources for transmitting sensing signals in corresponding sensing modes are configured, so that transmitting sensing signals based on the configured frequency-domain resources to sense the sensing target can be easily achieved, thereby improving the sensing accuracy.

In the method for configuring the sensing resource provided in embodiments of the present disclosure, the resource configuration information is determined by at least one of the following ways: the resource configuration information is determined by an access network device, or the resource configuration information is determined by a sensing function entity.

In some embodiments, the resource configuration information can be determined by the access network device.

In some embodiments, in response to a case where the sensing mode for performing sensing is to use an access network device to transmit a sensing signal, for example, the Sensing Mode 1. If the sending and receiving of sensing signals are performed by the same access network device, the resource configuration information can be determined by the access network device itself.

In some embodiments, in response to a case where the sensing mode for performing sensing is to use an access network device to transmit a sensing signal, for example, the Sensing Mode 2, where the GNB A sends the sensing signal and the gNB B receives the sensing signal. The resource configuration information can be determined by the gNB A and/or the gNB B through the Xn interface between the gNB A and the gNB B. The resource configuration information can also be determined by the gNB A and informed to the gNB B, or the resource configuration information is determined by the gNB B and informed to the gNB A.

In some embodiments, after determining the resource configuration information, the access network device can send the determined resource configuration information to the sensing function entity. That is, the access network device informs the sensing function entity of the resource configuration information. In some embodiments, the access network device can also not inform the sensing function entity of the determined resource configuration information.

In some embodiments, in response to a case where the sensing mode for performing sensing is to use an access network device and a terminal to transmit a sensing signal, for example, the Sensing Mode 5 and/or the Sensing Mode 6. After determining the resource configuration information, the access network device can directly inform the terminal. Alternatively, the access network device can inform the sensing function entity of the resource configuration information, and then the sensing function entity can inform the terminal.

In some embodiments, the resource configuration information can be determined by the sensing function entity.

In some embodiments, in scenes of Sensing Mode 1, Sensing Mode 2, Sensing Mode 5, and/or Sensing Mode 6, the access network device can inform the sensing function entity of its available resources. Afterwards, the sensing function entity determines one or more available resources based on available resources of one or more access network devices, and obtains the resource configuration information. Then, the sensing function entity informs the one or more access network devices or the terminal(s) of the determined resource configuration information.

In some embodiments, the resource configuration information can be determined by the access network device and the sensing function entity.

The present disclosure provides multiple ways to determine the resource configuration information, based on which, the time-frequency domain resources for transmitting sensing signals in corresponding sensing modes can be configured, so that transmitting sensing signals based on the configured time-frequency domain resources to sense the sensing target can be easily achieved, thereby improving the sensing accuracy.

In the method for configuring the sensing resource provided in embodiments of the present disclosure, in response that a sensing mode for performing sensing is to use a terminal to transmit a sensing signal, the time-domain resource includes an uplink time slot or an uplink symbol.

In some embodiments, in response to a case where the sensing mode for performing sensing is to use a terminal to transmit a sensing signal, the time-domain resource for transmitting the sensing signal can include the uplink time slot or the uplink symbol.

In some embodiments, the sensing mode can be Sensing Mode 3 or Sensing Mode 4. In these two sensing modes, the terminal which serves as the sensing node can use the time-domain resource occupying the uplink time slot or the uplink symbol when sending and/or receiving sensing signals.

According to the present disclosure, the time-domain resources for transmitting sensing signals in corresponding sensing modes are configured, so that transmitting sensing signals based on the configured time-domain resources to sense the sensing target can be easily achieved, thereby improving the sensing accuracy.

In the method for configuring the sensing resource provided in embodiments of the present disclosure, a last symbol in a time unit where the sensing signal is located is a guard gap symbol, and a first symbol in the time unit where the sensing signal is located is an AGC symbol. The guard gap symbol is not used for transmission, or the guard gap symbol is used for repeated transmission between terminals.

In some embodiments, in the case that the time-domain resource includes the uplink time slot or the uplink symbol, the last symbol in the time unit where the sensing signal is located can be used as a guard gap symbol during transmission. In some embodiments, the guard gap symbol is not used for transmission, or the guard gap symbol is used for repeated transmission between terminals. In some embodiments, the first symbol in the time unit where the sensing signal is located is the AGC symbol. The AGC symbol is mainly used for power adjustment.

It can be understood that, similar to the signal transmission in the sidelink, there is also a delay in transmitting sensing signals between different terminals. Therefore, when transmitting sensing signals, the last symbol in the time unit where the sensing signal is located needs to compensate for such delay. That is, when transmitting sensing signals, the last symbol in the time unit where the sensing signal is located is used as the guard gap symbol. Moreover, in consideration that the location of the terminal usually changes flexibly, and thus the distance between different terminals usually changes quickly. Therefore, when transmitting sensing signals, it is necessary to use the first symbol in the time unit where the sensing signal is located for power adjustment, that is, the first symbol in the time unit where the sensing signal is located is used as the AGC symbol.

According to the present disclosure, the configured time-domain resource includes the guard gap symbol, which can compensate for the time delay generated during the transmission of the sensing signal, thereby improving the sensing accuracy when sensing the sensing target.

In the method for configuring the sensing resource provided in embodiments of the present disclosure, in response that a sensing mode for performing sensing is to use a terminal to transmit a sensing signal, the frequency-domain resource includes at least one of the following resources: a SL BWP; an UL BWP; or a third BWP dedicated to sensing.

In some embodiments, in response to a case where the sensing mode for performing sensing is to use a terminal to transmit a sensing signal, the frequency-domain resource can include the SL BWP.

It can be understood that the frequency-domain resource including the SL BWP means that the SL BWP used for transmission between terminal devices is multiplexed. When the terminal uses the SL BWP to transmit the sensing signal, the sensing signal can be multiplexed with other SL signals or channels. In some embodiments, the transmission can be performed using TDM, FDM, SDM, or groups of different DMRS ports.

In some embodiments, in response to a case where the sensing mode for performing sensing is to use a terminal to transmit a sensing signal, the frequency-domain resource can include the UL BWP.

It can be understood that since the terminal transmits the sensing signal over the uplink time slot or the uplink symbol, the terminal can directly use the UL BWP used for the data transmission between it and the access network device during such a time period. Therefore, the transmission between terminals can multiplex the UL BWP over the uplink time slot or the uplink symbol.

In some embodiments, in response to a case where the sensing mode for performing sensing is to use a terminal to transmit a sensing signal, the frequency-domain resource can include the third BWP dedicated to sensing.

It can be understood that the third BWP is the BWP used by the terminal to transmit the sensing signal specially. The third BWP is neither a multiplexed SL BWP nor a multiplexed DL BWP.

It should be noted that the first BWP, the second BWP, and the third BWP involved in the present disclosure can be the same or different, which is not limited in the present disclosure.

According to the present disclosure, the frequency-domain resources for transmitting sensing signals in corresponding sensing modes are configured, so that transmitting sensing signals based on the configured frequency-domain resources to sense the sensing target can be easily achieved, thereby improving the sensing accuracy.

In the method for configuring the sensing resource provided in embodiments of the present disclosure, the resource configuration information is determined by at least one of the following ways: the resource configuration information is determined by an access network device, the resource configuration information is determined by a sensing function entity, or the resource configuration information is determined by a terminal based on resources in a resource pool.

In some embodiments, the resource configuration information can be determined by the access network device.

In some embodiments, in response to a case where the sensing mode for performing sensing is to use a terminal to transmit a sensing signal, for example, the Sensing Mode 3 and/or the Sensing Mode 4. The resource configuration information can be determined by the access network device and then informed to the terminal.

In some embodiments, after determining the resource configuration information, the access network device can send the determined resource configuration information to the sensing function entity. That is, the access network device informs the sensing function entity of the resource configuration information. In some embodiments, the access network device can also not inform the sensing function entity of the determined resource configuration information.

In some embodiments, the resource configuration information can be determined by the sensing function entity.

In some embodiments, in scenes of Sensing Mode 3 and/or Sensing Mode 4, the access network device can inform the sensing function entity of its available resources. Afterwards, based on one or more available resources, the sensing function entity determines one or more available resources for both the terminal and/or the access network device, and obtains the resource configuration information. Then, the sensing function entity informs one or more terminals of the determined resource configuration information.

In some embodiments, the sensing function entity can also inform the access network device of the determined resource configuration information.

In some embodiments, the resource configuration information can be determined by the terminal based on the resources in the resource pool.

In some embodiments, similar to the SL resource allocation, the access network device can allocate or indicate a resource pool. The terminal selects and reserves corresponding resources based on the resource pool by itself, and determines the resource configuration information for transmitting sensing signals.

In some embodiments, the resource configuration information can also be determined by the access network device and the sensing function entity, or determined by the access network device and the terminal based on the resources in the resource pool, or determined by the sensing function entity and the terminal based on the resources in the resource pool, or determined by the access network device, the sensing function entity, and the terminal based on the resources in the resource pool.

The present disclosure provides multiple ways to determine the resource configuration information, based on which, the time-frequency domain resources for transmitting sensing signals in corresponding sensing modes can be configured, so that transmitting sensing signals based on the configured time-frequency domain resources to sense the sensing target can be easily achieved, thereby improving the sensing accuracy.

In the method for configuring the sensing resource provided in embodiments of the present disclosure, the time unit is either a slot or a mini-slot.

In some embodiments, the time unit where the sensing signal is located can be a slot.

In some embodiments, the time unit where the sensing signal is located can be a mini-slot.

It can be understood that the mini-slot is a sub slot architecture. The mini-slot transforms the smallest scheduling unit from a time slot to a symbol, so as to achieve symbol-level scheduling, which can reduce the waiting time for data transmission and is suitable for a scene of low latency and small data volume.

In some embodiments, the features of the mini-slot can include at least one of the following: a slot can contain multiple mini-slot time units, a mini-slot can occupy symbols over multiple slots, or a mini-slot contains a minimum of 1 or 2 symbols.

The present disclosure is adapted to scenes in which multiple time units are supported. According to the present disclosure, the time-domain resources for transmitting sensing signals in corresponding sensing modes are configured, so that transmitting sensing signals based on the configured time-domain resources to sense the sensing target can be easily achieved, thereby improving the sensing accuracy.

In the method for configuring the sensing resource provided in embodiments of the present disclosure, the time-domain resource configuration information includes at least one of following parameters: a period, a starting time slot location, a starting symbol location, a number of occupied symbols, a number of sensing signal resources within a resource window for sending a sensing signal, or a number of time slots or symbols spaced between adjacent sensing signal resources within a resource window for sending a sensing signal.

In some embodiments, the time-domain resource configuration information can include a period.

For example, the time-domain resource configuration information includes a period of a sensing signal resource, a period of a resource window for sending a sensing signal, etc.

In some embodiments, the time-domain resource configuration information can include a starting time slot location.

For example, the time-domain resource configuration information includes a starting time slot location of the sensing signal resource or a starting time slot location of the resource window for sending a sensing signal.

In some embodiments, the time-domain resource configuration information can include a starting symbol location.

For example, the time-domain resource configuration information includes a starting symbol location of the sensing signal resource or a starting symbol location of the resource window for sending a sensing signal.

In some embodiments, the time-domain resource configuration information can include a number of occupied symbols.

For example, the time-domain resource configuration information includes a number of symbols occupied by the sensing signal resource.

In some embodiments, the time-domain resource configuration information can include a number of sensing signal resources within a resource window for sending a sensing signal.

For example, the time-domain resource configuration information includes a number of sensing signal resources within a window for sending a sensing signal. It can be understood that the sensing signal can be sent for multiple times within a window for sending a sensing signal. However, if some sensing signal resource is occupied by other channels/signals, the sensing signal will not be able to be sent on the corresponding sensing signal resource. Also, for different devices, there may be some resource locations that cannot be used for transmitting the data. That is, the number of sensing signal resources within the window for sending a sensing signal represents the number of sensing signal resources that can be used for transmitting sensing signals within a sensing signal window.

In some embodiments, the time-domain resource configuration information can include a number of time slots or symbols spaced between adjacent sensing signal resources within a resource window for sending a sensing signal.

For example, the time-domain resource configuration information includes a number of time slots spaced between adjacent two sensing signal resources within the resource window for sending a sensing signal, or a number of symbols spaced between adjacent two sensing signal resources within the resource window for sending a sensing signal.

In some embodiments, the time-domain resource configuration information can also include following combinations: a period, and a starting time slot location; a starting symbol location, a number of occupied symbols, and a number of sensing signal resources within a resource window for sending a sensing signal; a period, a starting time slot location, a starting symbol location, and a number of occupied symbols; a period, a starting time slot location, a starting symbol location, a number of occupied symbols, and a number of sensing signal resources within a resource window for sending a sensing signal; a period, a starting time slot location, a starting symbol location, a number of occupied symbols, a number of sensing signal resources within a resource window for sending a sensing signal, and a number of time slots or symbols spaced between adjacent sensing signal resources within a resource window for sending a sensing signal.

It can be understood that the time-domain resource configuration information provided in the present disclosure can also include any two, three, four, five, or six items mentioned above, which will not be listed one by one here.

The present disclosure provides multiple parameter configurations for the time-domain resources, based on which, the time-domain resources for transmitting sensing signals in corresponding sensing modes can be configured, so that transmitting sensing signals based on the configured time-domain resources to sense the sensing target can be easily achieved, thereby improving the sensing accuracy.

In the method for configuring the sensing resource provided in embodiments of the present disclosure, the frequency-domain resource configuration information includes at least one of following parameters: a bandwidth, a starting PRB location, a comb value, or a starting RE location.

In some embodiments, the frequency-domain resource configuration information can include a bandwidth.

In some embodiments, the frequency-domain resource configuration information can include a starting PRB location.

In some embodiments, the frequency-domain resource configuration information can include a comb value.

For example, a PRB contains 12 REs, and a sensing signal only occupies a portion of REs. For example, if two sensing signals occupy all 12 REs, then the comb value is 2. One of the two sensing signals occupies the 1^{st}, 3^{rd}, 5^{th}, . . . , 11^{th} RE, and the other sensing signal occupies the 2^{nd}, 4^{th}, 6^{th}, . . . , 12^{th} RE. It can be understood that the comb value represents a spaced value of the sensing signal occupying the RE, that is, a number of REs spaced between adjacent REs among REs respectively occupied by the sensing signals.

In some embodiments, the frequency-domain resource configuration information can include a starting RE location.

For example, assuming that the comb value is 2, the starting RE location can be the first RE, i.e. RE #0, or the second RE, i.e. RE #1. For example, if the comb value is 3, the starting RE location can be the first RE, i.e. RE #0, the second RE, i.e. RE #1, or the third RE, i.e. RE #2.

In some embodiments, the frequency-domain resource configuration information can also include following combinations: a bandwidth, and a starting PRB location; a bandwidth, and a comb value; a bandwidth, and a starting RE location; a starting PRB location, and a comb value; a starting PRB location, and a starting RE location; a comb value, and a starting RE location; a bandwidth, a starting PRB location, and a comb value; a bandwidth, a starting PRB location, and a starting RE location; a bandwidth, a comb value, and a starting RE location; a starting PRB location, a comb value, and a starting RE location; a bandwidth, a starting PRB location, a comb value, and a starting RE location.

The present disclosure provides multiple parameter configurations for the frequency-domain resources, based on which, the frequency-domain resources for transmitting sensing signals in corresponding sensing modes can be configured, so that transmitting sensing signals based on the configured frequency-domain resources to sense the sensing target can be easily achieved, thereby improving the sensing accuracy.

In the method for configuring the sensing resource provided in embodiments of the present disclosure, the resource configuration information also includes at least one of following parameters: subcarrier spacing, a CP, QCL information, a sensing signal resource identifier, a sensing signal sequence identifier, power information, or a path loss reference signal.

In some embodiments, the resource configuration information also includes the subcarrier spacing.

In some embodiments, the resource configuration information also includes the CP.

In some embodiments, the resource configuration information also includes the QCL information.

In some embodiments, the QCL information can include a TCI state or spatial relationship information. It can be understood that the QCL information can include downlink receiving beam information, uplink transmitting beam information, and beam information for SL. The beam information for SL can also indicate the reference signal identifier of the SL reference signal, for example, S-SSB and/or the SL CSI-RS.

It can be understood that the identifier in the present disclosure can be an ID or an index.

In some embodiments, the resource configuration information also includes the sensing signal resource identifier.

For example, the resource configuration information also includes the sensing signal resource ID.

In some embodiments, the resource configuration information also includes the sensing signal sequence identifier.

For example, the resource configuration information also includes the sensing signal sequence ID. It can be understood that the sensing signal sequence represents various different sensing signals.

In some embodiments, the resource configuration information also includes the power information.

In some embodiments, the resource configuration information also includes the path loss reference signal.

In some embodiments, the resource configuration information also includes following combinations: subcarrier spacing, and a CP; QCL information, a sensing signal resource identifier, and a sensing signal sequence identifier; subcarrier spacing, a CP, QCL information, and a sensing signal resource identifier; subcarrier spacing, a CP, QCL information, a sensing signal resource identifier, and a sensing signal sequence identifier; subcarrier spacing, a CP, QCL information, a sensing signal resource identifier, a sensing signal sequence identifier, and power information; subcarrier spacing, a CP, QCL information, a sensing signal resource identifier, a sensing signal sequence identifier, power information, and a path loss reference signal.

It can be understood that the resource configuration information includes the time-domain resource and/or the frequency-domain resource, and can also include any two, three, four, five, six, or seven parameters mentioned above, which will not be listed one by one in the present disclosure.

The present disclosure provides multiple parameter configurations for the resource configuration information, based on which, the time-frequency domain resources for transmitting sensing signals in corresponding sensing modes can be configured, so that transmitting sensing signals based on the configured time-frequency domain resources to sense the sensing target can be easily achieved, thereby improving the sensing accuracy.

In the method for configuring the sensing resource provided in embodiments of the present disclosure, the first device is an access network device or a terminal, and the second device is an access network device or a terminal different from the first device, or a sensing function entity.

In some embodiments, the first device can be an access network device.

In some embodiments, the first device can be a terminal.

In some embodiments, the second device can be an access network device. It can be understood that the second device is an access network device different from the first device.

In some embodiments, the second device can be a terminal. It can be understood that the second device is a terminal different from the first device.

In some embodiments, the second device can be a sensing function entity.

The present disclosure is applicable to various device scenes. According to the present disclosure, the time-frequency domain resources for transmitting sensing signals in corresponding sensing modes are configured, so that transmitting sensing signals based on the configured time-frequency domain resources to sense the sensing target can be easily achieved, thereby improving the sensing accuracy.

It can be understood that in the above embodiments, the sensing signal is sent to sense the sensing target, and a sensing measurement result can be obtained. In some embodiments, the specific content of the sensing measurement result can include at least one of the following measurements: a distance, a speed, or an angle. In some embodiments, more other measurements can also be included. In some embodiments, each measurement can further include at least one of following parameters of the corresponding measurement: a maximum value, a minimum value, or granularity (i.e. resolution). In some embodiments, more other parameters can also be included, which are not limited in the present disclosure.

It should be noted that those skilled in the art can understand that various embodiments/implementations mentioned in the present disclosure can be implemented in conjunction with the aforementioned embodiments or independently. Whether implemented alone or in conjunction with the aforementioned embodiments, the implementation principles are similar. In the present disclosure, some embodiments are described as being implemented together, and those skilled in the art can understand that such embodiments do not limit the present disclosure.

Based on the same concept, the present disclosure also provides an apparatus and a device for configuring a sensing resource.

It can be understood that the apparatus and the device for configuring the sensing resource provided by embodiments of the present disclosure include a hardware structure and/or a software module corresponding to each function in order to realize the above functions. In combination with the units and algorithm steps disclosed in embodiments of the present disclosure, embodiments of the present disclosure can be implemented in the form of hardware or a combination of hardware and computer software. Whether a function is implemented in the form of hardware or computer software driving the hardware depends on a specific application and design constraints of a technical solution. Those skilled in the art can use different methods to implement the described functions for each specific application, but such an implementation should not be considered beyond the scope of technical solutions of embodiments of the present disclosure.

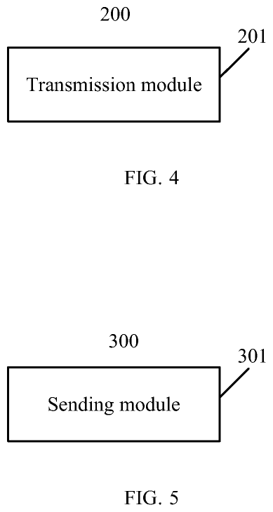

FIG. 4 is a schematic diagram of an apparatus for configuring a sensing resource according to one or more embodiments. Referring to FIG. 4, the apparatus 200 is configured in a first device and includes a transmission module 201 configured to receive resource configuration information sent by a second device. The resource configuration information is configured to indicate a resource location where the first device transmits a sensing signal, and the resource configuration information includes time-domain resource configuration information indicating a time-domain resource and/or frequency-domain resource configuration information indicating a frequency-domain resource. The transmission module 201 is further configured to transmit the sensing signal based on the resource location. The sensing signal is used to sense a sensing target.

According to the present disclosure, the time-frequency domain resources for transmitting sensing signals are configured, so that transmitting sensing signals based on the configured time-frequency domain resources to sense the sensing target can be easily achieved, thereby improving the sensing accuracy.

In some embodiments, in response that a sensing mode for performing sensing is to use an access network device to transmit the sensing signal, the time-domain resource includes a downlink time slot or a downlink symbol.

According to the present disclosure, the time-domain resources for transmitting sensing signals in corresponding sensing modes are configured, so that transmitting sensing signals based on the configured time-domain resources to sense the sensing target can be easily achieved, thereby improving the sensing accuracy.

In some embodiments, a last symbol in a time unit where the sensing signal is located is a guard gap symbol, and the guard gap symbol is not configured for transmission, or the guard gap symbol is configured for repeated transmission between access network devices.

According to the present disclosure, the configured time-domain resource includes the guard gap symbol, which can compensate for the time delay generated during the transmission of the sensing signal, thereby improving the sensing accuracy when sensing the sensing target.

In some embodiments, in response that a sensing mode for performing sensing is to use an access network device to transmit the sensing signal, the frequency-domain resource includes at least one of the following resources: a sidelink bandwidth part (BWP); a downlink BWP; or a first BWP dedicated to sensing.

According to the present disclosure, the frequency-domain resources for transmitting sensing signals in corresponding sensing modes are configured, so that transmitting sensing signals based on the configured frequency-domain resources to sense the sensing target can be easily achieved, thereby improving the sensing accuracy.

In some embodiments, in response that a sensing mode for performing sensing is to use an access network device and a terminal to transmit the sensing signal, the time-domain resource includes at least one of: a downlink time slot or a downlink symbol; an uplink time slot or an uplink symbol; or a flexible time slot or symbol.

According to the present disclosure, the time-domain resources for transmitting sensing signals in corresponding sensing modes are configured, so that transmitting sensing signals based on the configured time-domain resources to sense the sensing target can be easily achieved, thereby improving the sensing accuracy.

In some embodiments, in response that a sensing mode for performing sensing is to use an access network device and a terminal to transmit the sensing signal, the frequency-domain resource includes at least one of following resources: a downlink BWP; an uplink BWP; or a second BWP dedicated to sensing.

According to the present disclosure, the frequency-domain resources for transmitting sensing signals in corresponding sensing modes are configured, so that transmitting sensing signals based on the configured frequency-domain resources to sense the sensing target can be easily achieved, thereby improving the sensing accuracy.

In some embodiments, the resource configuration information is determined by at least one of: an access network device; or a sensing function entity.

The present disclosure provides multiple ways to determine the resource configuration information, based on which, the time-frequency domain resources for transmitting sensing signals in corresponding sensing modes can be configured, so that transmitting sensing signals based on the configured time-frequency domain resources to sense the sensing target can be easily achieved, thereby improving the sensing accuracy.

In some embodiments, in response that a sensing mode for performing sensing is to use a terminal to transmit the sensing signal, the time-domain resource includes an uplink time slot or an uplink symbol.

According to the present disclosure, the time-domain resources for transmitting sensing signals in corresponding sensing modes are configured, so that transmitting sensing signals based on the configured time-domain resources to sense the sensing target can be easily achieved, thereby improving the sensing accuracy.

In some embodiments, a last symbol in a time unit where the sensing signal is located is a guard gap symbol, a first symbol in the time unit where the sensing signal is located is an automatic gain control (AGC) symbol, and the guard gap symbol is not configured for transmission, or the guard gap symbol is configured for repeated transmission between terminals.

According to the present disclosure, the configured time-domain resource includes the guard gap symbol, which can compensate for the time delay generated during the transmission of the sensing signal, thereby improving the sensing accuracy when sensing the sensing target.

In some embodiments, in response that a sensing mode for performing sensing is to use a terminal to transmit the sensing signal, the frequency-domain resource includes at least one of: a sidelink BWP; an uplink BWP; or a third BWP dedicated to sensing.

According to the present disclosure, the frequency-domain resources for transmitting sensing signals in corresponding sensing modes are configured, so that transmitting sensing signals based on the configured frequency-domain resources to sense the sensing target can be easily achieved, thereby improving the sensing accuracy.

In some embodiments, the resource configuration information is determined by at least one of: an access network device; a sensing function entity; or a terminal based on resources in a resource pool.

The present disclosure provides multiple ways to determine the resource configuration information, based on which, the time-frequency domain resources for transmitting sensing signals in corresponding sensing modes can be configured, so that transmitting sensing signals based on the configured time-frequency domain resources to sense the sensing target can be easily achieved, thereby improving the sensing accuracy.

In some embodiments, the time unit is a time slot or a mini-slot.

The present disclosure is adapted to scenes in which multiple time units are supported. According to the present disclosure, the time-domain resources for transmitting sensing signals in corresponding sensing modes are configured, so that transmitting sensing signals based on the configured time-domain resources to sense the sensing target can be easily achieved, thereby improving the sensing accuracy.

In some embodiments, the time-domain resource configuration information includes at least one of following parameters: a period; a starting time slot location; a starting symbol location; a number of occupied symbols; a number of sensing signal resources within a resource window for sending the sensing signal; or a number of time slots or symbols spaced between adjacent sensing signal resources within the resource window for sending the sensing signal.

The present disclosure provides multiple parameter configurations for the time-domain resources, based on which, the time-domain resources for transmitting sensing signals in corresponding sensing modes can be configured, so that transmitting sensing signals based on the configured time-domain resources to sense the sensing target can be easily achieved, thereby improving the sensing accuracy.

In some embodiments, the frequency-domain resource configuration information includes at least one of following parameters: a bandwidth; a starting physical resource block (PRB) location; a comb value; or a starting resource element (RE) location.

The present disclosure provides multiple parameter configurations for the frequency-domain resources, based on which, the frequency-domain resources for transmitting sensing signals in corresponding sensing modes can be configured, so that transmitting sensing signals based on the configured frequency-domain resources to sense the sensing target can be easily achieved, thereby improving the sensing accuracy.

In some embodiments, the resource configuration information further includes at least one of following parameters: subcarrier spacing; a cyclic prefix (CP); quasi co-location (QCL) information; a sensing signal resource identifier; a sensing signal sequence identifier; power information; or a path loss reference signal.

The present disclosure provides multiple ways to determine the resource configuration information, based on which, the time-frequency domain resources for transmitting sensing signals in corresponding sensing modes can be configured, so that transmitting sensing signals based on the configured time-frequency domain resources to sense the sensing target can be easily achieved, thereby improving the sensing accuracy.

In some embodiments, the first device is an access network device or a terminal, and the second device is an access network device different from the first device, a terminal different from the first device, or a sensing function entity.

The present disclosure is applicable to various device scenes. According to the present disclosure, the time-frequency domain resources for transmitting sensing signals in corresponding sensing modes are configured, so that transmitting sensing signals based on the configured time-frequency domain resources to sense the sensing target can be easily achieved, thereby improving the sensing accuracy.

FIG. 5 is a schematic diagram of an apparatus for configuring a sensing resource according to one or more embodiments. Referring to FIG. 5, the apparatus 300 is configured in a second device and includes a sending module 301 configured to send resource configuration information to a first device. The resource configuration information is configured to indicate a resource location where the first device transmits a sensing signal, the resource configuration information includes time-domain resource configuration information indicating a time-domain resource and/or frequency-domain resource configuration information indicating a frequency-domain resource, the resource configuration information is further configured for the first device to transmit the sensing signal based on the resource location, and the sensing signal is used to sense a sensing target.

According to the present disclosure, the time-frequency domain resources for transmitting sensing signals are configured, so that transmitting sensing signals based on the configured time-frequency domain resources to sense the sensing target can be easily achieved, thereby improving the sensing accuracy.

In some embodiments, in response that a sensing mode for performing sensing is to use an access network device to transmit the sensing signal, the time-domain resource includes a downlink time slot or a downlink symbol.

According to the present disclosure, the time-domain resources for transmitting sensing signals in corresponding sensing modes are configured, so that transmitting sensing signals based on the configured time-domain resources to sense the sensing target can be easily achieved, thereby improving the sensing accuracy.

In some embodiments, a last symbol in a time unit where the sensing signal is located is a guard gap symbol, and the guard gap symbol is not configured for transmission, or the guard gap symbol is configured for repeated transmission between access network devices.

According to the present disclosure, the configured time-domain resource includes the guard gap symbol, which can compensate for the time delay generated during the transmission of the sensing signal, thereby improving the sensing accuracy when sensing the sensing target.

In some embodiments, in response that a sensing mode for performing sensing is to use an access network device to transmit the sensing signal, the frequency-domain resource includes at least one of the following resources: a sidelink bandwidth part (BWP); a downlink BWP; or a first BWP dedicated to sensing.

According to the present disclosure, the frequency-domain resources for transmitting sensing signals in corresponding sensing modes are configured, so that transmitting sensing signals based on the configured frequency-domain resources to sense the sensing target can be easily achieved, thereby improving the sensing accuracy.

In some embodiments, in response that a sensing mode for performing sensing is to use an access network device and a terminal to transmit the sensing signal, the time-domain resource includes at least one of: a downlink time slot or a downlink symbol; an uplink time slot or an uplink symbol; or a flexible time slot or symbol.

According to the present disclosure, the time-domain resources for transmitting sensing signals in corresponding sensing modes are configured, so that transmitting sensing signals based on the configured time-domain resources to sense the sensing target can be easily achieved, thereby improving the sensing accuracy.

In some embodiments, in response that a sensing mode for performing sensing is to use an access network device and a terminal to transmit the sensing signal, the frequency-domain resource includes at least one of following resources: a downlink BWP; an uplink BWP; or a second BWP dedicated to sensing.

According to the present disclosure, the frequency-domain resources for transmitting sensing signals in corresponding sensing modes are configured, so that transmitting sensing signals based on the configured frequency-domain resources to sense the sensing target can be easily achieved, thereby improving the sensing accuracy.

In some embodiments, the resource configuration information is determined by at least one of: an access network device; or a sensing function entity.

The present disclosure provides multiple ways to determine the resource configuration information, based on which, the time-frequency domain resources for transmitting sensing signals in corresponding sensing modes can be configured, so that transmitting sensing signals based on the configured time-frequency domain resources to sense the sensing target can be easily achieved, thereby improving the sensing accuracy.

In some embodiments, in response that a sensing mode for performing sensing is to use a terminal to transmit the sensing signal, the time-domain resource includes an uplink time slot or an uplink symbol.

According to the present disclosure, the time-domain resources for transmitting sensing signals in corresponding sensing modes are configured, so that transmitting sensing signals based on the configured time-domain resources to sense the sensing target can be easily achieved, thereby improving the sensing accuracy.

In some embodiments, a last symbol in a time unit where the sensing signal is located is a guard gap symbol, a first symbol in the time unit where the sensing signal is located is an automatic gain control (AGC) symbol, and the guard gap symbol is not configured for transmission, or the guard gap symbol is configured for repeated transmission between terminals.

According to the present disclosure, the configured time-domain resource includes the guard gap symbol, which can compensate for the time delay generated during the transmission of the sensing signal, thereby improving the sensing accuracy when sensing the sensing target.

In some embodiments, in response that a sensing mode for performing sensing is to use a terminal to transmit the sensing signal, the frequency-domain resource includes at least one of: a sidelink BWP; an uplink BWP; or a third BWP dedicated to sensing.

According to the present disclosure, the frequency-domain resources for transmitting sensing signals in corresponding sensing modes are configured, so that transmitting sensing signals based on the configured frequency-domain resources to sense the sensing target can be easily achieved, thereby improving the sensing accuracy.

In some embodiments, the resource configuration information is determined by at least one of: an access network device; a sensing function entity; or a terminal based on resources in a resource pool.

The present disclosure provides multiple ways to determine the resource configuration information, based on which, the time-frequency domain resources for transmitting sensing signals in corresponding sensing modes can be configured, so that transmitting sensing signals based on the configured time-frequency domain resources to sense the sensing target can be easily achieved, thereby improving the sensing accuracy.

In some embodiments, the time unit is a time slot or a mini-slot.

The present disclosure is adapted to scenes in which multiple time units are supported. According to the present disclosure, the time-domain resources for transmitting sensing signals in corresponding sensing modes are configured, so that transmitting sensing signals based on the configured time-domain resources to sense the sensing target can be easily achieved, thereby improving the sensing accuracy.

In some embodiments, the time-domain resource configuration information includes at least one of following parameters: a period; a starting time slot location; a starting symbol location; a number of occupied symbols; a number of sensing signal resources within a resource window for sending the sensing signal; or a number of time slots or symbols spaced between adjacent sensing signal resources within the resource window for sending the sensing signal.

The present disclosure provides multiple parameter configurations for the time-domain resources, based on which, the time-domain resources for transmitting sensing signals in corresponding sensing modes can be configured, so that transmitting sensing signals based on the configured time-domain resources to sense the sensing target can be easily achieved, thereby improving the sensing accuracy.

In some embodiments, the frequency-domain resource configuration information includes at least one of following parameters: a bandwidth; a starting physical resource block (PRB) location; a comb value; or a starting resource element (RE) location.

The present disclosure provides multiple parameter configurations for the frequency-domain resources, based on which, the frequency-domain resources for transmitting sensing signals in corresponding sensing modes can be configured, so that transmitting sensing signals based on the configured frequency-domain resources to sense the sensing target can be easily achieved, thereby improving the sensing accuracy.

In some embodiments, the resource configuration information further includes at least one of following parameters: subcarrier spacing; a cyclic prefix (CP); quasi co-location (QCL) information; a sensing signal resource identifier; a sensing signal sequence identifier; power information; or a path loss reference signal.

The present disclosure provides multiple ways to determine the resource configuration information, based on which, the time-frequency domain resources for transmitting sensing signals in corresponding sensing modes can be configured, so that transmitting sensing signals based on the configured time-frequency domain resources to sense the sensing target can be easily achieved, thereby improving the sensing accuracy.

In some embodiments, the first device is an access network device or a terminal, and the second device is an access network device different from the first device, a terminal different from the first device, or a sensing function entity.

The present disclosure is applicable to various device scenes. According to the present disclosure, the time-frequency domain resources for transmitting sensing signals in corresponding sensing modes are configured, so that transmitting sensing signals based on the configured time-frequency domain resources to sense the sensing target can be easily achieved, thereby improving the sensing accuracy.

It should be noted that the various modules/units involved in the apparatus 200 and apparatus 300 disclosed in embodiments of the present disclosure are only for illustrative purposes and are not limited to them. For example, the apparatus 200 in some embodiments of the present disclosure can also include a processing module. The transmission module 201 can be configured to receive and send information. For example, the apparatus 300 in some embodiments of the present disclosure can also include a receiving module and/or a processing module. In some embodiments, the modules included in apparatus 200 and apparatus 300 can interact with each other or with other network element devices.

As for the apparatus in the above embodiments, the specific ways in which each module performs operations have been described in detail in the relevant method embodiments, and will not be elaborated here.

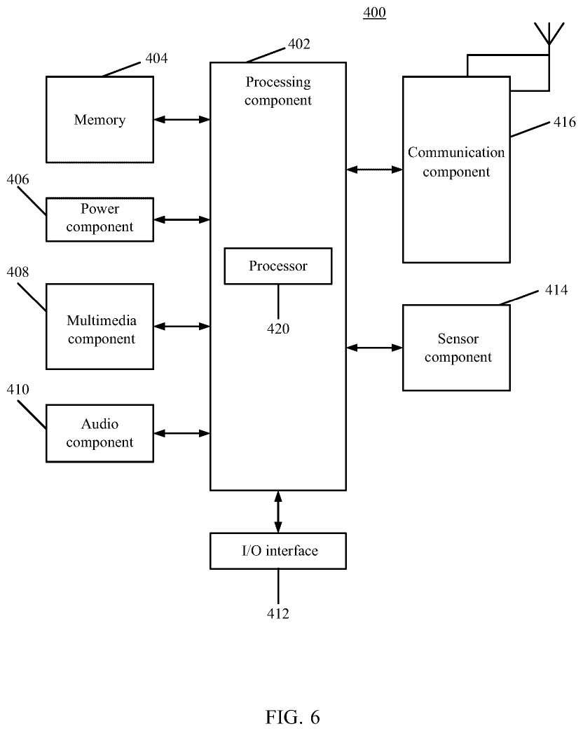

FIG. 6 is a schematic diagram of a communication sensing device according to one or more embodiments of the present disclosure. For example, a device 400 can be any terminal such as a mobile phone, a computer, a digital broadcasting terminal, a messaging device, a game console, a tablet device, a medical device, a fitness device, a personal digital assistant, etc.

In some embodiments, the first device and/or the second device can be the terminal.

Referring to FIG. 6, device 400 can include at least one of the following components: a processing component 402, a memory 404, a power component 406, a multimedia component 408, an audio component 410, an input/output (I/O) interface 412, a sensor component 414, and a communication component 416.

The processing component 402 typically controls the overall operation of the device 400, such as operations associated with display, telephone call, data communication, camera operation, and recording operations. The processing component 402 may include one or more processors to execute instructions to complete all or part of the methods described above. In addition, the processing component 402 may include one or more modules to facilitate interactions between the processing component 402 and other components. For example, the processing component 402 may include a multimedia module to facilitate interaction between the multimedia component 408 and the processing component 402.

The memory 404 is configured to store various types of data to support operations in the device 400. Examples of such data include instructions, contact data, phone book data, messages, pictures, videos, and the like for any application or method operating on the device 400. The memory 404 can be implemented by any type of volatile or non-volatile storage device or their combination, such as static random access memory (SRAM), electrically erasable programmable read-only memory (EEPROM), erasable programmable read-only memory (EPROM), programmable read-only memory (PROM), read-only memory (ROM), magnetic memory, flash memory, disk or optical disk.

The power component 406 provides power for various components of the device 400. The power component 406 may include a power management system, one or more power supplies, and other components associated with generating, managing, and distributing power for the device 400.

The multimedia component 408 includes a display screen providing an output interface between the device 400 and the user. In some embodiments, the screen may include a liquid crystal display (LCD) and a touch panel (TP). If the screen includes a touch panel, the screen can be implemented as a touch screen to receive input signals from the user. The touch panel includes one or more touch sensors to sense touch, sliding, and gestures on the touch panel. The touch sensor can not only sense the boundaries of touch or sliding actions, but also detect the duration and pressure related to the touch or sliding operation. In some embodiments, the multimedia component 408 includes a front camera and/or a rear camera. When the device 400 is in operation mode, such as shooting mode or video mode, the front camera and/or rear camera can receive external multimedia data. Each front camera and rear camera can be a fixed optical lens system or have focal length and optical zoom capability.

The audio component 410 is configured to output and/or input audio signals. For example, the audio component 410 includes a microphone (MIC), which is configured to receive an external audio signal when the device 400 is in an operation mode, such as a calling mode, a recording mode, and a voice recognition mode. The received audio signal may be further stored in memory 404 or transmitted via communication component 416. In some embodiments, the audio component 410 also includes a speaker for outputting audio signals.

The I/O interface 412 provides an interface between the processing component 402 and peripheral interface modules, which can be a keyboard, click wheel, button, etc. These buttons may include, but are not limited to, the Home button, Volume button, Start button, and Lock button.

The sensor component 414 includes one or more sensors for providing various aspects of condition evaluation for the device 400. For example, the sensor component 414 can detect an open/closed state of the device 400, relative positioning of the components. The component is, for example, a display and a keypad of the device 400. The sensor component 414 can also detect changes in the position of the device 400 or one component of the device 400, presence or absence of the user's contact with the device 400, orientation or acceleration/deceleration of the device 400 and temperature change of the device 400. The sensor component 414 may include a proximity sensor configured to detect the presence of nearby objects without any physical contact. The sensor component 414 may also include a light sensor, such as a CMOS or CCD image sensor, for use in imaging applications. In some embodiments, the sensor component 414 may also include an acceleration sensor, a gyroscope sensor, a magnetic sensor, a pressure sensor, or a temperature sensor.

The communication component 416 is configured to facilitate wired or wireless communication between the device 400 and other devices. The device 400 can access wireless networks based on communication standards, such as WiFi, 2G or 3G, or a combination thereof. In some embodiments, the communication component 416 receives a broadcast signal or broadcast related information from an external broadcast management system via a broadcast channel. In some embodiments, the communication component 416 also includes a near field communication (NFC) module to facilitate short range communication. For example, the NFC module can be implemented based on radio frequency identification (RFID) technology, infrared data association (IrDA) technology, ultra wideband (UWB) technology, Bluetooth (BT) technology and other technologies.

In some embodiments, the device 400 can be implemented through one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components, for implementing above methods.

In some embodiments, a non-transitory computer-readable storage medium including instructions is also provided, such as the memory 404 including instructions, which can be executed by the processor 320 of the device 400 to complete above methods. For example, the non-transitory computer-readable storage medium can be ROM, random access memory (RAM), CD-ROM, tapes, floppy disks, optical data storage devices, etc.

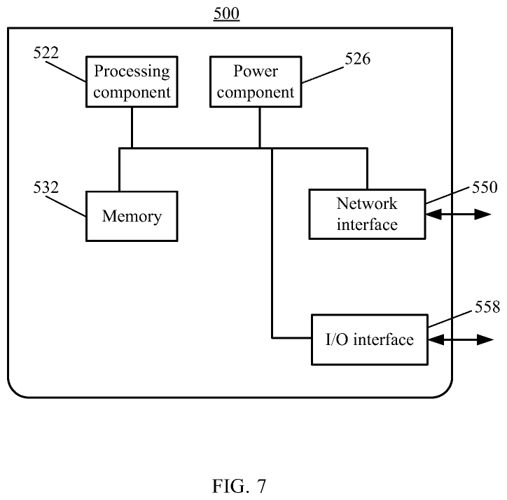

FIG. 7 is a schematic diagram of a communication sensing device according to one or more embodiments of the present disclosure. In some embodiments, a device 500 can be provided as a base station or a server. In some embodiments, the first device and/or the second device can be an access network device, for example, a base station, where the base station can be the gNB. In some embodiments, the second device is a sensing function entity. Referring to FIG. 7, the device 500 includes a processing component 522, which further includes one or more processors, as well as memory resources represented by a memory 532, for storing instructions that can be executed by the processing component 522, such as application programs. The application programs stored in memory 532 can include one or more modules corresponding to a set of instructions. In addition, the processing component 522 is configured to execute instructions to implement the method described above.

The device 500 can further include a power component 526 configured to perform power management of the device 500, a wired or wireless network interface 550 configured to connect the device 500 to the network, and an input and output (I/O) interface 558. The device 500 can operate operating systems stored in the memory 532, such as Windows Server™, Mac OS X™, Unix™, Linux™, FreeBSD™, or similar systems.

The present disclosure aims to improve the accuracy of communication sensing by configuring the time-domain and frequency-domain resources of sensing signals corresponding to various communication sensing modes.

It should be further understood that “multiple” in the present disclosure refers to two or more, and other quantifiers are similar. “And/or” describes an association relationship between associated objects, indicating that there can be three relationships. For example, A and/or B can indicate that A alone, both A and B, or B alone. The character “/”′ generally indicates that the associated objects have an “or” relationship. The singular forms “one”, “a” and “the” are also intended to include majority forms, unless the context clearly indicates otherwise.

It should be further understood that the terms “first”, “second” and the like are used to describe various kinds of information, but such information should not be limited to these terms. These terms are only used to distinguish the same type of information from each other, and do not indicate a specific order or importance. In fact, the expressions “first” and “second” can be used interchangeably. For example, without departing from the scope of the present disclosure, the first information can also be referred to as the second information, and similarly, the second information can also be referred to as the first information.

It can be further understood that the meanings of words such as “in response to” and “if” mentioned in the present disclosure depend on the context and the actual application scenario. For example, the word “in response to” used herein can be interpreted as “when”, “while”, or “if”.

It should be further understood that although the operations in embodiments of the present disclosure are described in a specific order in the drawings, they should not be understood that these operations are required to be performed in the specific order or serial order shown, or that all of the operations shown are required to be performed to achieve the desired results. Multitasking and parallel processing may be advantageous in a particular environment.

After considering the specification and practices of the invention disclosed herein, those skilled in the art will easily come up with other implementation solutions of the present disclosure. The present disclosure aims to cover any variations, uses, or adaptive changes of the present disclosure, which follow the general principles of the present disclosure and include common knowledge or commonly used technical means in the art that are not disclosed in the present disclosure.

It should be understood that the present disclosure is not limited to the precise structure described above and shown in the drawings, and various modifications and changes can be made without departing from its scope. The scope of the present disclosure is limited only by the appended claims.

1. A method for configuring a sensing resource, performed by a first device, the method comprising:
receiving resource configuration information sent by a second device, wherein the resource configuration information is configured to indicate a resource location where the first device transmits a sensing signal, and the resource configuration information comprises at least one of time-domain resource configuration information indicating a time-domain resource or frequency-domain resource configuration information indicating a frequency-domain resource; and
transmitting the sensing signal based on the resource location, wherein the sensing signal is used to sense a sensing target.

2. The method according to claim 1, wherein a sensing mode for performing sensing comprises using an access network device to transmit the sensing signal, and the time-domain resource comprises a downlink time slot or a downlink symbol.

3. The method according to claim 2, wherein a last symbol in a time unit where the sensing signal is located is a guard gap symbol, and wherein the guard gap symbol is not configured for transmission, or the guard gap symbol is configured for repeated transmission between access network devices.

4. The method according to claim 1, wherein a sensing mode for performing sensing comprises using an access network device to transmit the sensing signal, and the frequency-domain resource comprises at least one of:
a sidelink bandwidth part (BWP);
a downlink BWP; or
a first BWP dedicated to sensing.

5. The method according to claim 1, wherein a sensing mode for performing sensing comprises using an access network device and a terminal to transmit the sensing signal, and the time-domain resource comprises at least one of:
a downlink time slot or a downlink symbol;
an uplink time slot or an uplink symbol; or
a flexible time slot or symbol.

6. The method according to claim 1, wherein a sensing mode for performing sensing comprises using an access network device and a terminal to transmit the sensing signal, and the frequency-domain resource comprises at least one of:
a downlink BWP;
an uplink BWP; or
a second BWP dedicated to sensing.

7. The method according to claim 1, wherein the resource configuration information is determined by at least one of:
an access network device;
a sensing function entity; or
a terminal based on resources in a resource pool.

8. The method according to claim 1, wherein a sensing mode for performing sensing comprises using a terminal to transmit the sensing signal, and the time-domain resource comprises an uplink time slot or an uplink symbol.

9. The method according to claim 8, wherein a last symbol in a time unit where the sensing signal is located is a guard gap symbol, and a first symbol in the time unit where the sensing signal is located is an automatic gain control (AGC) symbol, and wherein the guard gap symbol is not configured for transmission, or the guard gap symbol is configured for repeated transmission between terminals.

10. The method according to claim 1, wherein a sensing mode for performing sensing comprises using a terminal to transmit the sensing signal, and the frequency-domain resource comprises at least one of:
a sidelink BWP;
an uplink BWP; or
a third BWP dedicated to sensing.

11. (canceled)

12. The method according to claim 3, wherein the time unit is a time slot or a mini-slot.

13. The method according to claim 1, wherein the resource configuration information comprises at least one of following parameters:
a period;
a starting time slot location;
a starting symbol location;
a number of occupied symbols;
a number of sensing signal resources within a resource window for sending the sensing signal;
a number of time slots or symbols spaced between adjacent sensing signal resources within the resource window for sending the sensing signal;
a bandwidth;
a starting physical resource block (PRB) location;
a comb value;
a starting resource element (RE) location;
subcarrier spacing;
a cyclic prefix (CP);
quasi co-location (QCL) information;
a sensing signal resource identifier;
a sensing signal sequence identifier;
power information; or
a path loss reference signal.

14. (canceled)

15. (canceled)

16. The method according to claim 1, wherein the first device is an access network device or a terminal, and the second device is an access network device different from the first device, a terminal different from the first device, or a sensing function entity.

17. A method for configuring a sensing resource, performed by a second device, the method comprising:
sending resource configuration information to a first device, wherein the resource configuration information is configured to indicate a resource location where the first device transmits a sensing signal, the resource configuration information comprises at least one of time-domain resource configuration information indicating a time-domain resource or frequency-domain resource configuration information indicating a frequency-domain resource, the resource configuration information is further configured for the first device to transmit the sensing signal based on the resource location, and the sensing signal is used to sense a sensing target.

18. The method according to claim 17, wherein a sensing mode for performing sensing comprises using an access network device to transmit the sensing signal, and the time-domain resource comprises a downlink time slot or a downlink symbol; or
wherein a sensing mode for performing sensing comprises using the access network device and a terminal to transmit the sensing signal, and the time-domain resource comprises at least one of:
a downlink time slot or a downlink symbol;
an uplink time slot or an uplink symbol; or
a flexible time slot or symbol; or
wherein a sensing mode for performing sensing comprises using the terminal to transmit the sensing signal, and the time-domain resource comprises an uplink time slot or an uplink symbol.

19. (canceled)

20. The method according to claim 17, wherein a sensing mode for performing sensing comprises using an access network device to transmit the sensing signal, and the frequency-domain resource comprises at least one of:
a sidelink bandwidth part (BWP);
a downlink BWP; or
a first BWP dedicated to sensing; or
wherein a sensing mode for performing sensing comprises using the access network device and a terminal to transmit the sensing signal, and the frequency-domain resource comprises at least one of:
a downlink BWP;
an uplink BWP; or
a second BWP dedicated to sensing; or
wherein a sensing mode for performing sensing comprises using a terminal to transmit the sensing signal, and the frequency-domain resource comprises at least one of:
a sidelink BWP;
an uplink BWP; or
a third BWP dedicated to sensing.

21. (canceled)

22. (canceled)

23. The method according to claim 17, wherein the resource configuration information is determined by at least one of:
an access network device;
a sensing function entity; or
a terminal based on resources in a resource pool.

24-34. (canceled)

35. A device for configuring a sensing resource, comprising:
a processor; and
a memory used to store executable instructions for the processor;
wherein the processor is configured to perform the method according to claim 1.

36. A device for configuring a sensing resource, comprising:
a processor; and
a memory used to store executable instructions for the processor;
wherein the processor is configured to perform the method according to claim 17.

37. A non-transitory computer-readable storage medium, wherein when instructions in the storage medium are executed by a processor of a first device, cause the first device to perform the method according to claim 1.

38. (canceled)
